(19) United States
(12) Patent Application Publication
(10) Pub. No.: US 2025/0218609 A1
(43) Pub. Date: Jul. 3, 2025

(54) PLASMA FOCUS SYSTEMS AND METHODS WITH ENHANCED NEUTRON YIELD

(71) Applicant: FUSE ENERGY TECHNOLOGIES CORP., San Leandro, CA (US)

(72) Inventors: Sing Lee, Chadstone, Victoria (AU); Vahid Damideh, Napierville, Quebec (CA); Jean-Christoph Btaiche, Napierville, Quebec (CA)

(73) Assignee: FUSE ENERGY TECHNOLOGIES CORP., San Leandro, CA (US)

(21) Appl. No.: 18/850,540

(22) PCT Filed: Apr. 21, 2023
(86) PCT No.: PCT/US2023/019414

§ 371 Date: Sep. 24, 2024

Related U.S. Application Data
(60) Provisional application No. 63/363,448, filed on Apr. 22, 2022.

(51) Int. Cl. G21B 1/23; G21B 1/17; G21B 1/21; G21G 4/02

(52) U.S. Cl. CPC G21B 1/23; G21B 1/17; G21B 1/21; G21G 4/02

(57) ABSTRACT

A plasma focus system for neutron production is disclosed that includes a plasma focus device and a neutron source. The plasma focus device is configured to emit a remnant ion beam. The neutron source includes an enclosure having a cavity formed therein for receiving a target medium. Depending on the application, the target medium can be a gas, a liquid, or a solid. The enclosure includes a beam entrance port configured to allow at least part of the remnant ion beam to enter and travel inside the cavity. As the remnant ion beam travels along the cavity, the beam ions interact with the target medium and undergo both fusion collisions and non-fusion collisions. The fusion collisions produce neutrons and reduce a number of the beam ions, while the non-fusion collisions reduce an energy of the beam ions. A plasma focus method of neutron production is also disclosed.

### RELATED PATENT APPLICATION

The present application claims priority to U.S. Provisional Patent Application No. 63/363,448 filed on Apr. 22, 2022, the disclosure of which is incorporated herein by reference in its entirety.

### TECHNICAL FIELD

The technical field generally relates to plasma technologies and, more particularly, to plasma focus systems and methods.

### BACKGROUND

Dense plasma focus systems (or simply plasma focus systems) are pinch-based plasma generation systems in which a high pulsed voltage is applied between two coaxial electrodes disposed inside a vacuum chamber filled with a process or working gas. The coaxial electrodes extend from a closed end to an open end, with an electrical insulator disposed between the electrodes at the closed end. The application of the voltage leads to the ionization and breakdown of the gas on the insulator, and the formation of a plasma shockwave-current-sheath layer, hereinafter referred to as a plasma current sheath for simplicity. Under the effect of the Lorentz force created by the radial current flowing in the plasma and the current-induced azimuthal magnetic field, the current sheath is driven axially along the electrodes toward the open end. Upon reaching the open end, the current sheath is radially compressed onto the axis to form a hot and dense pinch plasma column. During the pinch phase, plasma instabilities can lead to the emission of electron and ion beams, electromagnetic radiation pulses (e.g., X-rays), and, if the process gas contains neutronic fusion fuel, neutrons. For example, neutrons at 2.45 MeV can be generated when using deuterium as the working gas, while neutrons at 14.1 MeV can be generated when using a deuterium-tritium mixture. In fusion power applications, the kinetic energy of the fusion neutrons is converted into thermal energy, which is subsequently converted into electricity. In conventional plasma focus devices, most of the neutrons are produced from beam-target reactions, with a small or negligible fraction originating from thermonuclear reactions.

### SUMMARY

The present description generally relates to plasma focus systems and methods for producing neutrons with enhanced yield through harvesting of remnant beam ions emitted from the plasma pinch to generate neutrons via beam-target fusion reactions with a target medium.

In accordance with an aspect, there is provided a plasma focus system for neutron production, the plasma focus system including:
a plasma focus device configured to emit a remnant ion beam including beam ions; and
a neutron source including an enclosure having a cavity formed therein for receiving a target medium, the enclosure including a beam entrance port configured to allow at least part of the remnant ion beam to enter and travel inside the cavity,
wherein, as the remnant ion beam travels along the cavity, the beam ions interact with the target medium and undergo fusion collisions, which produce neutrons and reduce a number of the beam ions, and non-fusion collisions, which reduce an energy of the beam ions.

In some embodiments, as the remnant ion beam travels inside the cavity, the non-fusion collisions gradually reduce the energy of the beam ions from a first energy range to a second energy range, and a beam-target fusion cross-section between the beam ions and the target medium increases from within the first energy range to within the second energy range, thereby causing the fusion collisions to produce the neutrons with a gradually increasing neutron yield. In some embodiments, the first energy range extends from about 1 MeV to about 20 MeV, and the second energy range extends from about 1 keV to about 200 keV. In some embodiments, the second energy range encompasses a maximum in the beam-target fusion cross-section between the beam ions and the target medium. In some embodiments, the maximum in the beam-target fusion cross-section between the beam ions and the target medium is at a beam ion energy of about 115 keV.

In some embodiments, the beam ions include deuterons and tritons, the target medium includes a mixture of deuterium and tritium, and the neutrons are produced by the D-T fusion reaction. In some embodiments, the beam ions include deuterons, the target medium includes tritium, and the neutrons are produced by the D-T fusion reaction. In some embodiments, the beam ions include deuterons, the target medium includes deuterium, and the neutrons are produced by the D-D fusion reaction. In some embodiments, the beam ions include tritons, the target medium includes deuterium, and the neutrons are produced by the D-T fusion reaction.

In some embodiments, the plasma focus device further emits primary neutrons, and the neutrons produced by the neutron source correspond to secondary neutrons.

In some embodiments, the enclosure extends between a first enclosure end, proximal to the plasma focus device, and a second enclosure end distal from the plasma focus device, and the beam entrance port is provided at the first enclosure end. In some embodiments, the beam entrance port includes a beam entrance window. In some embodiments, the beam entrance port includes a beam shutter, wherein the beam shutter is movable between a closed shutter position, wherein the remnant ion beam is prevented from entering the cavity, and an open shutter position, wherein the remnant ion beam is allowed to enter inside the cavity.

In some embodiments, the target medium is a target gas. In some embodiments, the target gas includes deuterium, tritium, or a mixture of deuterium and tritium. In some embodiments, a fill pressure of the target gas inside the cavity ranges from about 2 atm to about 6 atm. In some embodiments, the enclosure has a length ranging from about 50 cm to about 2 m. In some embodiments, the enclosure includes a target gas inlet formed therein, and the neutron source includes a target gas supply unit configured to supply the target gas inside the cavity via the target gas inlet.

In some embodiments, the target medium is a target solid. In some embodiments, the target solid includes D₂O ice, T₂O ice, or a mixture of D₂O ice and T₂O ice. In some embodiments, the enclosure has a length ranging from about 5 mm to about 20 mm.

In some embodiments, the target medium is a target liquid. In some embodiments, the target liquid includes D₂O water, T₂O water, or a mixture of D₂O water and T₂O water. In some embodiments, the enclosure has a length ranging from about 5 mm to about 20 mm.

In some embodiments, the plasma focus device includes:
an electrode assembly including:
   an inner electrode extending along a pinch axis between a discharge end and a focus end; and
   an outer electrode surrounding the inner electrode and defining therebetween a plasma channel configured to receive a process gas; and
a power supply unit configured to apply a discharge driving signal to the inner electrode and the outer electrode, wherein applying the discharge driving signal causes the process gas to be ionized into a plasma current sheath at the discharge end and the plasma current sheath to flow along the plasma channel and reach the focus end where the plasma current sheath collapses toward the pinch axis to form a plasma pinch from which the remnant ion beam is emitted.

In some embodiments, the enclosure extends along an enclosure axis that is coaxial with respect to the pinch axis. In some embodiments, the enclosure is spaced from a pinch region of the plasma focus device by a separation distance ranging from about 4 cm to about 120 cm.

In some embodiments, the plasma focus device includes a vacuum chamber configured to contain the process gas therein and to house at least part of the enclosure, including the beam entrance port. In some embodiments, the target medium is a target gas, and a fill pressure of the target gas inside the cavity is higher than a fill pressure of the process gas inside the vacuum chamber. In some embodiments, the process gas includes deuterium, tritium, or a mixture of deuterium and tritium. In some embodiments, the plasma focus device includes a process gas supply unit configured to supply the process gas inside the plasma channel.

In some embodiments, the power supply unit includes a pulsed-DC power supply including a capacitor bank and a switch. In some embodiments, the power supply unit is configured to apply the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.

In some embodiments, the neutron source includes a target gas recycling unit configured to recover at least part of remaining target gas after interaction with the remnant ion beam and recycle the remaining target for use in further production of secondary neutrons.

In accordance with another aspect, there is provided a plasma focus method of neutron production, the method including:
operating a plasma focus device to emit a remnant ion beam including beam ions;
providing a neutron source including an enclosure having a cavity with a target medium thereinside; and
allowing at least part of the remnant ion beam to enter and travel inside the cavity, wherein, as the remnant ion beam travels inside the cavity, the beam ions interact with the target mediums and undergo fusion collisions, which produce neutrons and reduce a number of the beam ions, and non-fusion collisions, which reduce an energy of the beam ions.

In some embodiments, providing the neutron source includes supplying the target medium inside the cavity.

In some embodiments, as the remnant ion beam travels inside the cavity, the non-fusion collisions gradually reduce the energy of the beam ions from a first energy range to a second energy range, and a beam-target fusion cross-section between the beam ions and the target medium increases from within the first energy range to within the second energy range, thereby causing the fusion collisions to produce the neutrons with a gradually increasing neutron yield. In some embodiments, the first energy range extends from about 1 MeV to about 20 MeV, and the second energy range extends from about 1 keV to about 200 keV. In some embodiments, the second energy range encompasses a maximum in the beam-target fusion cross-section between the beam ions and the target medium. In some embodiments, the maximum in the beam-target fusion cross-section between the beam ions and the target medium is at a beam ion energy of about 115 keV.

In some embodiments, the beam ions include deuterons and tritons, the target medium includes a mixture of deuterium and tritium, and the neutrons are produced by the D-T fusion reaction. In some embodiments, the beam ions include deuterons, the target medium includes tritium, and the neutrons are produced by the D-T fusion reaction. In some embodiments, the beam ions include deuterons, the target medium includes deuterium, and the neutrons are produced by the D-D fusion reaction. In some embodiments, the beam ions include tritons, the target medium includes deuterium, and the neutrons are produced by the D-T fusion reaction.

In some embodiments, operating the plasma focus device includes emitting primary neutrons, and the neutrons produced by the neutron source correspond to secondary neutrons.

In some embodiments, the enclosure extends between a first enclosure end and a second enclosure, the beam entrance port is provided at the first enclosure end, and providing the neutron source includes positioning the first enclosure end and the second enclosure end proximally to and distally from the plasma focus device, respectively.

In some embodiments, allowing at least part of the remnant ion beam to enter and travel inside the cavity includes providing the enclosure with a beam entrance window. In some embodiments, allowing at least part of the remnant ion beam to enter and travel inside the cavity includes providing the enclosure with a beam shutter movable between a closed shutter position, wherein the remnant ion beam is prevented from entering the cavity, and an open shutter position, wherein the remnant ion beam is allowed to enter inside the cavity, and switching the beam shutter from the closed shutter position to the open shutter position in coordination with the operating of the plasma focus device.

In some embodiments, the target medium is a target gas. In some embodiments, the target gas includes deuterium, tritium, or a mixture of deuterium and tritium. In some embodiments, the method further includes controlling a fill pressure of the target gas inside the cavity to range from about 2 atm to about 6 atm. In some embodiments, providing the neutron source includes providing the enclosure with a length ranging from about 50 cm to about 2 m.

In some embodiments, the target medium is a target solid or a target liquid. In some embodiments, the target medium includes D₂O ice or water, T₂O ice or water, or a mixture of D₂O ice or water and T₂O ice or water. In some embodiments, providing the neutron source includes providing the enclosure with a length ranging from about 5 mm to about 20 mm.

In some embodiments, operating the plasma focus device includes:
providing the plasma focus system with an inner electrode extending along a pinch axis between a discharge end and a focus end, and an outer electrode surrounding the inner electrode with an interelectrode gap therebetween defining an annular plasma channel;
supplying a process gas inside the plasma channel; and
applying a discharge driving signal to the inner electrode and the outer electrode to ionize the process gas into a plasma current sheath at the discharge end and flow the plasma current sheath along the plasma channel until the plasma current sheath reaches the focus end and radially collapses toward the pinch axis to form a plasma pinch generating the remnant ion beam.

In some embodiments, applying the discharge driving signal includes applying the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.

In some embodiments, the process gas includes deuterium, tritium, or a mixture of deuterium and tritium.

In some embodiments, providing the neutron source includes positioning an enclosure axis of the enclosure in a coaxial arrangement with the pinch axis.

In some embodiments, the method further includes recovering at least part of remaining target gas after interaction with the remnant ion beam and recycling the remaining target for use in further production of neutrons.

In accordance with another aspect, there is provided plasma focus system for neutron production, the plasma focus system including:
a plasma focus device configured to emit an ion beam including beam ions; and
a neutron source including an enclosure having a cavity formed therein for receiving a target medium, the enclosure including a beam entrance port configured to allow at least part of the ion beam to enter and travel inside the cavity,
wherein, as the ion beam travels along the cavity, the beam ions interact with the target medium and undergo both fusion collisions via the D-T reaction, which produce neutrons and gradually reduce a number of the beam ions, and non-fusion collisions, which gradually reduce an energy of the beam ions from a first energy range to a second energy range,
wherein a beam-target D-T fusion cross-section between the beam ions and the target medium increases from within the first energy range to within the second energy range, thereby causing the fusion collisions to produce the neutrons with a gradually increasing neutron yield,
wherein the second energy range encompasses a maximum in the beam-target D-T fusion cross-section between the beam ions and the target medium, and
wherein the maximum in the beam-target fusion cross-section between the beam ions and the target medium is about at a beam ion energy of about 115 keV.

In accordance with another aspect, there is provided a plasma focus method of neutron production, the method including:
operating a plasma focus device to emit a remnant ion beam including beam ions;
providing a neutron source including an enclosure having a cavity with a target medium thereinside; and
allowing at least part of the remnant ion beam to enter and travel inside the cavity, wherein, as the remnant ion beam travels inside the cavity, the beam ions interact with the target mediums and undergo fusion collisions via the D-T reaction, which produce neutrons and gradually reduce a number of the beam ions, and non-fusion collisions, which gradually reduce an energy of the beam ions from a first energy range to a second energy range.
wherein a beam-target D-T fusion cross-section between the beam ions and the target medium increases from within the first energy range to within the second energy range, thereby causing the fusion collisions to produce the neutrons with a gradually increasing neutron yield,
wherein the second energy range encompasses a maximum in the beam-target D-T fusion cross-section between the beam ions and the target medium, and
wherein the maximum in the beam-target fusion cross-section between the beam ions and the target medium is about at a beam ion energy of about 115 keV.

In accordance with another aspect, there is provided plasma focus system for neutron production, the plasma focus system including:
a plasma focus device configured to emit primary neutrons and an ion beam including beam ions; and
a secondary neutron source including an enclosure having a cavity formed therein for receiving a target gas, the enclosure including a beam entrance port configured to allow at least part of the ion beam to enter and travel inside the cavity, wherein, as the ion beam travels along the cavity, the bear ions interact with the target gas and undergo both fusion collisions, which produce secondary neutrons and reduce a number of the beam ions, and non-fusion collisions, which reduce an energy of the beam ions.

In some embodiments, the plasma focus device includes:
an electrode assembly including:
   an inner electrode extending along a pinch axis between a discharge end and a focus end; and
   an outer electrode surrounding the inner electrode with an interelectrode gap therebetween defining an annular plasma channel configured to receive therein a process gas; and
a power supply unit configured to apply a discharge driving signal to the inner electrode and the outer electrode, wherein the application of the discharge driving signal causes the process gas to be ionized into a plasma current sheath at the discharge end and the plasma current sheath to flow along the plasma channel and reach the focus end where the plasma current sheath radially collapses toward the pinch axis to form a plasma pinch from which the primary neutrons and the ion beam are emitted.

In accordance with another aspect, there is provided a plasma focus method of neutron production, the method including:
operating a plasma focus device to emit primary neutrons and an ion beam including beam ions;
providing an enclosure having a cavity formed therein for receiving a target gas; and
allowing at least part of the ion beam to enter and travel inside the cavity, wherein, as the ion beam travels along the cavity, the beam ions interact with the target gas and undergo both fusion collisions, which produce secondary neutrons and reduce a number of the beam ions, and non-fusion collisions, which reduce an energy of the beam ions.

In some embodiments, the step of operating the plasma focus device includes:
providing the plasma focus system with an inner electrode extending along a pinch axis between a discharge end and a focus end, and an outer electrode surrounding the inner electrode with an interelectrode gap therebetween defining an annular plasma channel;
supplying a process gas inside the plasma channel; and
applying a discharge driving signal to the inner electrode and the outer electrode to ionize the process gas into a plasma current sheath at the discharge end and flow the plasma current sheath along the plasma channel until the plasma current sheath reaches the focus end and radially collapses toward the pinch axis to form a plasma pinch generating the primary neutrons and the ion beam.

Other method and process steps may be performed prior, during, or after the steps described herein. The order of one or more steps may also differ, and some of the steps may be omitted, repeated, and/or combined, as the case may be.

Other objects, features, and advantages of the present description will become more apparent upon reading of the following non-restrictive description of specific embodiments thereof, given by way of example only with reference to the appended drawings. Although specific features described in the above summary and in the detailed description below may be described with respect to specific embodiments or aspects, it should be noted that these specific features may be combined with one another unless stated otherwise.

### BRIEF DESCRIPTION OF THE DRAWINGS

FIG. 1 depicts curves of the beam-target fusion cross-section σ_{b-t} plotted as functions of beam ion energy E on a log-log scale for the D-T and D-D reactions.

FIG. 2 is a schematic longitudinal cross-sectional view of a plasma focus system, in accordance with an embodiment.

FIG. 3 is a schematic longitudinal cross-sectional view of a plasma focus system, in accordance with another embodiment.

FIG. 4 is a flow diagram of a plasma focus method of neutron production, in accordance with another embodiment.

FIG. 5 is a schematic longitudinal cross-sectional view of a plasma focus system, in accordance with another embodiment.

FIG. 6 is a schematic longitudinal cross-sectional view of a plasma focus system, in accordance with another embodiment.

FIG. 7 is a schematic longitudinal cross-sectional view of a plasma focus system, in accordance with another embodiment.

FIG. 8 is a schematic longitudinal cross-sectional view of a plasma focus system, in accordance with another embodiment.

FIG. 9 is a schematic longitudinal cross-sectional view of a plasma focus system, in accordance with another embodiment.

FIG. 10 is a schematic longitudinal cross-sectional view of a plasma focus system, in accordance with another embodiment.

### DETAILED DESCRIPTION

In the present description, similar features in the drawings have been given similar reference numerals. To avoid cluttering certain figures, some elements may not be indicated if they were already identified in a preceding figure. The elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. Such spatially relative terms are intended to encompass different orientations in the use or operation of the present embodiments, in addition to the orientations exemplified in the figures. Furthermore, when a first element is referred to as being “on”, “above”, “below”, “over”, or “under” a second element, the first element can be either directly or indirectly on, above, below, over, or under the second element, respectively, such that one or multiple intervening elements may be disposed between the first element and the second element.

The terms “a”, “an”, and “one” are defined herein to mean “at least one”, that is, these terms do not exclude a plural number of elements, unless stated otherwise.

The term “or” is defined herein to mean “and/or”, unless stated otherwise.

The expressions “at least one of X, Y, and Z” and “one or more of X, Y, and Z”, and variants thereof, are understood to include X alone, Y alone, Z alone, any combination of X and Y, any combination of X and Z, any combination of Y and Z, and any combination of X, Y, and Z.

Terms such as “substantially”, “generally”, and “about”, which modify a value, condition, or characteristic of a feature of an exemplary embodiment, should be understood to mean that the value, condition, or characteristic is defined within tolerances that are acceptable for the proper operation of this exemplary embodiment for its intended application or that fall within an acceptable range of experimental error. In particular, the term “about” generally refers to a range of numbers that one skilled in the art would consider equivalent to the stated value (e.g., having the same or an equivalent function or result). In some instances, the term “about” means a variation of ±10% of the stated value. It is noted that all numeric values used herein are assumed to be modified by the term “about”, unless stated otherwise. The term “between” as used herein to refer to a range of numbers or values defined by endpoints is intended to include both endpoints, unless stated otherwise.

The term “based on” as used herein is intended to mean “based at least in part on”, whether directly or indirectly, and to encompass both “based solely on” and “based partly on”. In particular, the term “based on” may also be understood as meaning “depending on”, “representative of”, “indicative of”, “associated with”, “relating to”, and the like.

The terms “match”, “matching”, and “matched” refer herein to a condition in which two elements are either the same or within some predetermined tolerance of each other. That is, these terms are meant to encompass not only “exactly” or “identically” matching the two elements, but also “substantially”, “approximately”, or “subjectively” matching the two elements, as well as providing a higher or best match among a plurality of matching possibilities.

The terms “connected” and “coupled”, and derivatives and variants thereof, refer herein to any connection or coupling, either direct or indirect, between two or more elements, unless stated otherwise. For example, the connection or coupling between elements may be mechanical, optical, electrical, magnetic, thermal, chemical, fluidic, logical, operational, or any combination thereof.

The term “concurrently” refers herein to two or more processes that occur during coincident or overlapping time periods. The term “concurrently” does not necessarily imply complete synchronicity and encompasses various scenarios including time-coincident or simultaneous occurrence of two processes; occurrence of a first process that both begins and ends during the duration of a second process; and occurrence of a first process that begins during the duration of a second process, but ends after the completion of the second process.

The present description generally relates to plasma focus systems and methods for producing neutrons with an enhanced neutron yield through harvesting of remnant beam ions to generate neutrons via beam-target fusion reactions with a target medium. Depending on the application, the target medium can be a gas, a liquid, or a solid. The techniques disclosed herein may be used in various fields and applications that use neutrons, including, to name a few, fusion power applications, reactor wall testing, materials processing, and production of short-lived radioisotopes for medical purposes.

Nuclear fusion energy is energy produced by a nuclear fusion process in which at least two lighter atomic nuclei are joined to form a heavier nucleus whose mass is less than the sum of the masses of the lighter nuclei. The difference in mass is released as energy, which can be harnessed to produce electricity. Fusion reactions can be neutronic or aneutronic depending on whether the fusion reaction products include neutrons or not, in addition to charged nuclei. Non-limiting examples of neutronic fusion reactions include the deuterium-deuterium (D-D) reaction, which generates neutrons at 2.45 MeV, and the deuterium-tritium (D-T) reaction, which generates neutrons at 14.1 MeV.

Conventional plasma focus systems produce fusion neutrons predominantly, if not nearly exclusively, from beam-target fusion reactions, with only a small, if not negligible, proportion coming from thermonuclear fusion reactions [1]. Beam-target fusion neutrons are produced when a high-energy ion beam collides with a stationary ion target, whereas thermonuclear fusion neutrons are produced by fusion reactions between ions in the high-energy tail of the thermal ion population. The basic principles governing these two neutron production mechanisms in the context of plasma focus systems are generally known in the art and need not be described in detail herein other than to facilitate an understanding of the present techniques.

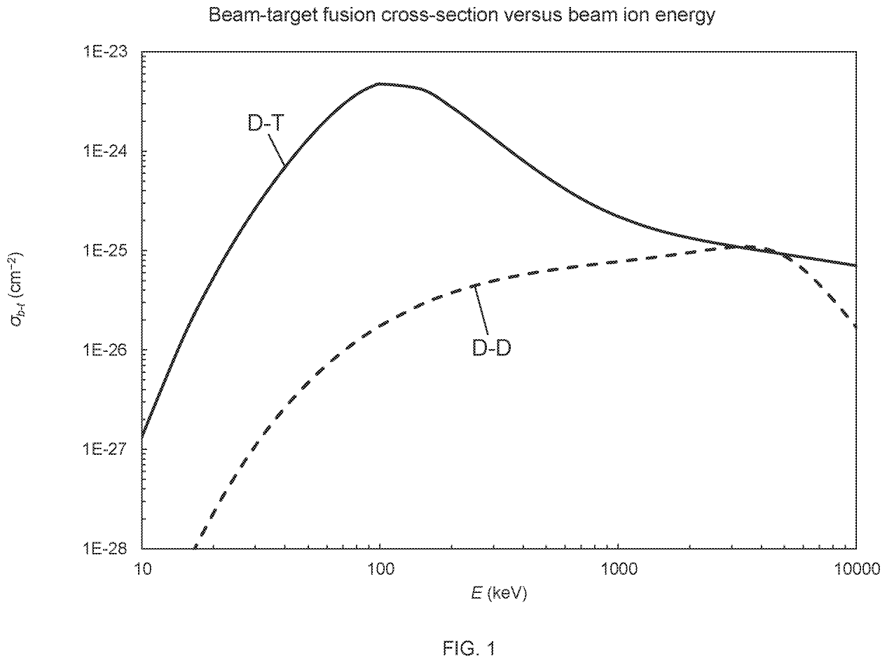

The beam-target fusion yield depends on the beam-target fusion cross-section σ_{b-t}(E), which is itself a function of the beam ion energy E. FIG. 1 depicts curves of the beam-target fusion cross-section (in cm²) plotted as functions of beam ion energy E (in keV) on a log-log scale, for the D-T reaction (solid line) and the D-D reaction (dashed line) (computed from [2], p. 44).

In small plasma focus devices (e.g., of the order of tens of kJ) operating in D-T (currently the most widely used fusion fuel), the beam ions responsible for producing beam-target fusion neutrons typically have energies of the order of the tens of keV. In this energy range, the value of the D-T fusion cross-section σ_{b-t} is about an order of magnitude below its optimum value, which is reached at a beam ion energy of about 115 keV. The induced voltage resulting in the beam ion energy depends on the current/that drives the radial current sheath. This induced voltage has the form I(dL/dt), where L is the plasma inductance. Thus, for high-current plasma focus devices operating in D-T, the beam ion energy can far exceed 115 keV, resulting in a loss in fusion neutron yield from the optimum value. For example, at beam energies of the order of 10 MeV, which can be achieved at currents of the order of 1 MA and higher, there is nearly a 100-fold decrease in the D-T fusion cross-section σ_{b-t} compared to beam ion energies of the order of 115 keV. These results can readily be calculated using the Lee model code [3], a widely recognized and verified [1; pp. 510-513] code used for simulating the operation of plasma focus systems.

The present techniques aim to provide plasma focus systems and methods for enhanced neutron production. In the present techniques, the loss in fusion neutron yield mentioned above, due to the beam energy being higher than the energy at which the beam-target fusion cross-section is maximum, can be avoided or at least mitigated. As described in greater detail below, this neutron production enhancement can be achieved at least in part by the provision of a plasma focus system that includes a plasma focus device configured to emit a remnant ion beam (or simply ion beam), and a neutron source acting as a fusion harvester. The neutron source includes an enclosure filled with a target medium and configured to receive and propagate therein at least part of the remnant ion beam emitted by a plasma focus device. Depending on the application, the target medium can be provided as a gas, a liquid, or solid. The neutron source produces neutrons via beam-target fusion reactions between the remnant ion beam and the target medium. Due to non-fusion collisions between the ion beam and the target medium, the beam-target fusion reactions occur at progressively lower beam ion energies—and thus with progressively higher neutron yields—as the remnant ion beam travels inside the cavity. In several embodiments, the plasma focus device also generates neutrons of its own. These neutrons can be referred to as “primary neutrons”, while the neutrons generated by the neutron source can be referred to as “secondary neutrons”. In such embodiments, the secondary neutrons add to the primary neutrons emitted by the plasma focus device to increase the total neutron yield of the plasma focus system.

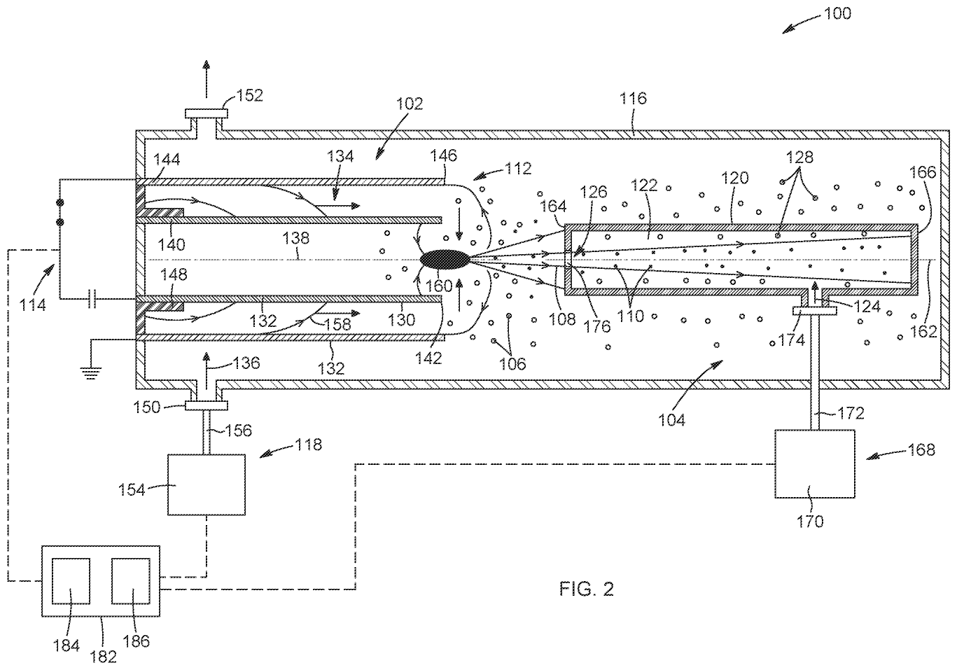

Referring to FIG. 2, there is illustrated a schematic longitudinal cross-sectional view of an embodiment of a plasma focus system 100 used for enhanced neutron production. The plasma focus system 100 of FIG. 2 generally includes a plasma focus device 102 and a neutron source 104 (or fusion harvester). The plasma focus device 102 is configured to emit primary neutrons 106 and a remnant ion beam 108 including beam ions 110. In the illustrated embodiment, the plasma focus device 102 generally includes an electrode assembly 112, a power supply unit 114, a vacuum chamber 116, and a process gas supply unit 118. The neutron source 104 includes an enclosure 120 having a cavity 122 formed therein for receiving a target medium. In the illustrated embodiment, the target medium is a target gas 124. The neutron source 104 also includes a beam entrance port 126 configured to allow at least part of the ion beam 108 to enter the cavity 122 for traveling thereinside, where the beam ions 110 can interact with the target gas 124 via both fusion and non-fusion collisions (or reactions). The fusion collisions produce neutrons 128, which in this embodiment will be referred to as secondary neutrons. The secondary neutrons 128 add to the primary neutrons 106 emitted by the plasma focus device 102 to increase the total neutron yield of the plasma focus system 100.

More details regarding the structure, configuration, and operation of these components and other possible components of the plasma focus system 100 are provided below. It is appreciated that FIG. 2 is a simplified schematic representation that illustrates certain features and components of the plasma focus system 100, such that additional features and components that may be useful or necessary for its practical operation may not be specifically depicted Non-limiting examples of such additional features and components can include, to name a few, power supplies, electrical connections, gas sources, gas supply lines (e.g., conduits, such as pipes or tubes), pressure and flow control devices (e.g., pumps, valves, regulators, restrictors), temperature control devices (e.g., chillers for the electrodes), operation monitoring and diagnostic devices (e.g., sensors), processors and controllers, and other types of hardware and equipment.

The electrode assembly 112 includes an inner electrode 130 and an outer electrode 132 forming a plasma gun. In FIG. 2, the inner electrode 130 is configured as an anode and the outer electrode 132 is configured as a cathode (i.e., the inner electrode 130 is positively biased with respect to the outer electrode 132), but reversing the polarity of the electrodes 130, 132 is possible in other embodiments. The outer electrode 132 surrounds the inner electrode 130 with an interelectrode radial gap therebetween defining an annular plasma channel 134 configured to receive therein a process gas 136. Each of the inner electrode 130 and the outer electrode 132 has an elongated configuration along a pinch axis 138. As used herein, the terms “longitudinal” and “axial” refer to a direction parallel to the pinch axis 138, while the terms “radial” and “transverse” refer to a direction that lies in a plane perpendicular to the pinch axis 138. The inner electrode 130 extends longitudinally between a discharge end 140 and a focus end 142, and the outer electrode 132 extends longitudinally between a discharge end 144 and a focus end 146. In some embodiments, the focus end 142 of the inner electrode 130 is longitudinally aligned with the focus end 146 of the outer electrode 132. In other embodiments, the focus end 142 of the inner electrode 130 is disposed longitudinally ahead or behind the focus end 146 of the outer electrode 132.

In FIG. 2, the inner electrode 130 and the outer electrode 132 both have a substantially cylindrical configuration, with a circular cross-section transverse to the pinch axis 138. The outer electrode 132 encloses the inner electrode 130 in a coaxial arrangement with respect to the pinch axis 138. Other electrode configurations may be used in other embodiments. Non-limiting examples include, to name a few, non-coaxial arrangements, non-circularly symmetric transverse cross-sections, and longitudinally tapered electrode configurations. In some embodiments, the inner electrode 130 may have a length ranging from about 4 cm to about 80 cm and a radius ranging from about 1 cm to about 30 cm. In some embodiments, the outer electrode 132 may have a length ranging from about 3 cm to about 100 cm, and a radius ranging from about 2 cm to about 40 cm. Other inner and outer electrode dimensions may be used in other embodiments. Depending on the application, the ratio of the length to the diameter of the inner electrode 130 can be greater than, equal to, or less than one.

The inner electrode 130 and the outer electrode 132 may each be made of any suitable electrically conductive material, such as various metals and metal alloys. Non-limiting examples include, to name a few, copper and brass. In some embodiments, the outer electrode 132 may have a hollow cylindrical body with a continuous circumferential surface. In other embodiments, the outer electrode 132 may include a set of rods extending longitudinally along and distributed azimuthally around the pinch axis 138, so that the outer electrode 132 has a discontinuous circumferential surface, with inter-rod gaps formed by the azimuthal spaces between the rods.

In the illustrated embodiment, the plasma channel 134 has a substantially annular cross-sectional shape defined by the cross-sectional shapes of the inner electrode 130 and the outer electrode 132. The plasma channel 134 has a closed end, at the discharge ends 140, 144 of the electrodes 130, 132, and an open end, at the focus ends 142, 146 of the electrodes 130, 132. As the plasma channel 134 forms a portion of the interior of the vacuum chamber 116, the plasma channel 134 is configured to receive and be filled by the process gas 136 supplied by the process gas supply unit 118.

The electrode assembly 112 of FIG. 2 also includes an electrode insulator 148 disposed between the inner electrode 130 and the outer electrode 132 at the discharge ends 140, 144 thereof. The electrode insulator 148 is configured to provide electrical insulation between the inner electrode 130 and the outer electrode 132. The electrode insulator 148 is also configured to provide a discharge surface on which the ionization and breakdown of the process gas 136 can be initiated. In the illustrated embodiment, the electrode insulator 148 has an annular cross-sectional shape, but other shapes are possible in other embodiments. Depending on the application, the electrode insulator 148 may be formed of one piece of material or multiple pieces of material. The electrode insulator 148 may be made of any suitable electrically insulating material. Non-limiting examples of such possible materials include, to name a few, alumina, ceramics, and quartz. Depending on the application, the electrode insulator 148 may be of varying sizes, shapes, compositions, locations, and configurations.

Referring still to FIG. 2, the power supply unit 114 is electrically connected to the inner electrode 130 and the outer electrode 132 via appropriate electrical connections. The term “power supply” refers herein to any device or combination of devices configured to supply electrical power into a form usable by another device or combination of devices. In some embodiments, the power supply unit 114 can include a pulsed high-power source (e.g., a capacitor bank, a Marx generator, or a linear transformer driver) and a switch (e.g., a spark gap, an ignitron, or a semiconductor switch) Other suitable types of power supplies may be used in other embodiments. The power supply unit 114 is configured to apply a discharge driving signal to the inner electrode 130 and the outer electrodes 132, so as to create a discharge voltage across the plasma channel 134. In some embodiments, the discharge driving signal is a voltage pulse having a peak magnitude ranging from about 12 kV to about 1 MV, a half-cycle pulse duration ranging from about 1 μs to about 50 μs, and a peak current amplitude ranging from about 100 kA to about 10 MA, although other peak magnitude voltage values, other pulse duration values, and other peak current amplitudes may be used in other embodiments. It is appreciated that the instrumentation, implementation, and operation of power supplies used in plasma focus systems are generally known in the art and need not be described in greater detail herein.

The vacuum chamber 116 is configured to house various components of the plasma focus system 100, including the plasma channel 134 defined in the annular gap formed between the inner electrode 130 and the outer electrode 132. The vacuum chamber 116 may be embodied by any suitable pressure vessel. In some embodiments, the vacuum chamber 116 may be provided as a cylindrical tank and coaxially enclosing the electrode assembly 112. The vacuum chamber 116 may be made of stainless steel or another suitable material. Various other configurations may be used in other embodiments. For example, in some embodiments, the outer electrode 132 may form part of the vacuum chamber 116. The vacuum chamber 116 can include at least one process gas inlet port 150 configured for connection to the process gas supply unit 118 to allow the process gas 136 to be introduced inside the vacuum chamber 116. The vacuum chamber 116 can also include various other ports, such as a vacuum pump port 152 and diagnostics ports (not shown). In some embodiments, the vacuum pump port 152 can be connected to a vacuum pump system (not shown) of sufficient capacity to achieve a base pressure lower than one hundredth of the lowest operational pressure when filled with the process gas 136. The vacuum chamber 116 may be connected to a pressure control unit (not shown) configured to control the fill pressure of the process gas 136 inside the vacuum chamber 116. In some embodiments, the fill pressure of the process gas 136 can range from about 1 Torr to about 100 Torr, although other ranges of fill pressure may be used in other embodiments.

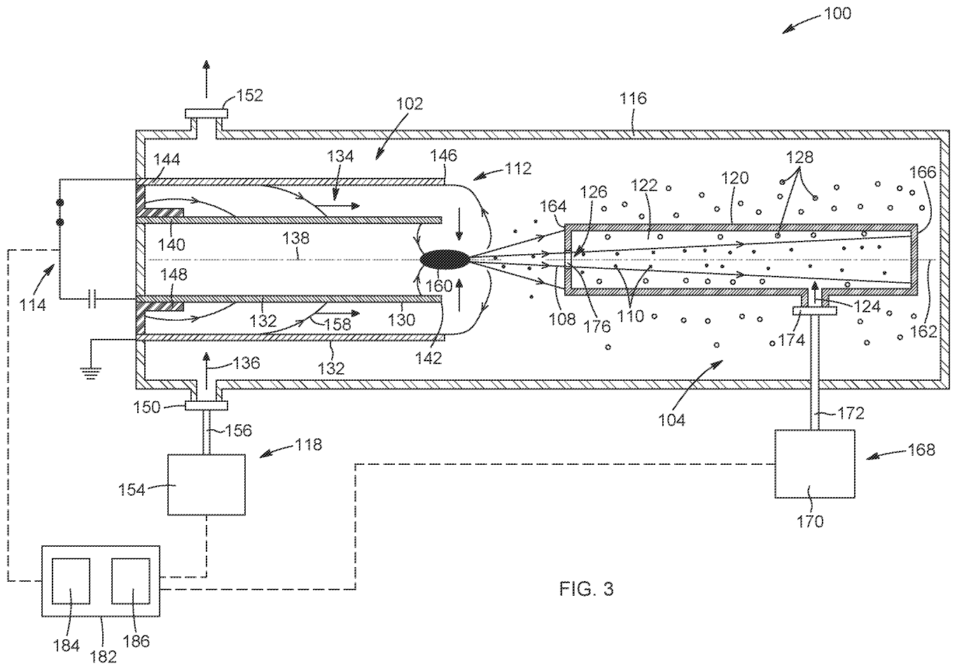

The process gas 136 can be any suitable gas or gas mixture from which fusion neutrons can be produced via neutronic fusion reactions by the plasma focus device 102. In some embodiments, the process gas 136 may be deuterium gas (to produce D-D neutrons) or a gas mixture containing deuterium and tritium (to produce D-T neutrons), or another suitable neutronic fusion fuel. In other embodiments, the process gas 136 may not include neutronic fusion fuel. For example, referring to FIG. 3, the process gas 136 may be composed of pure tritium gas. In such a case, the plasma focus device 102 is configured to emit a triton beam 108 without emission of primary neutrons.

Returning to FIG. 2, the process gas supply unit 118 can include or be coupled to a process gas source 154 configured to store the process gas 136. The process gas source 154 can be embodied by a gas storage tank or any suitable pressurized dispensing container. The process gas supply unit 118 can also include a process gas supply line 156 connected between the process gas source 154 and the process gas inlet port 150 of the vacuum chamber 116. The process gas supply line 156 is configured to allow the process gas 136 to enter and fill the interior of the vacuum chamber 116. The process gas supply unit 118 can also include various additional flow control devices (not shown), for example, valves, pumps, regulators, and restrictors, configured to control the introduction of the process gas 136 inside the vacuum chamber 116. It is appreciated that various configurations and arrangements are contemplated for the process gas supply unit 118, and that various gas injection techniques can be used.

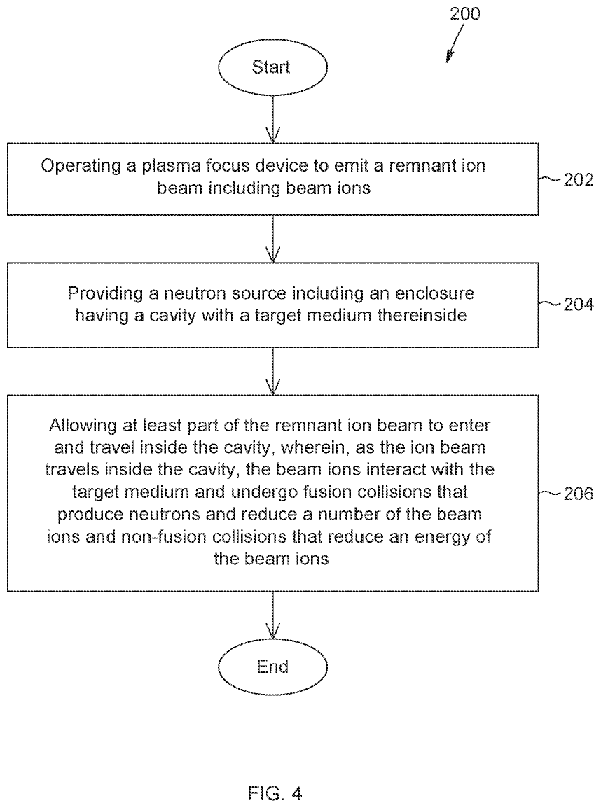

The operation of the plasma focus device 102 of FIG. 2 to generate the primary neutrons 106 and the remnant ion beam 108 will now be considered in greater detail. FIG. 4 is a flow diagram of an embodiment of a plasma focus method 200 of neutron production. It is appreciated that the theory and operation of the various phases of plasma focus dynamics—including the breakdown phase, the axial acceleration phase, the radial compression phase and the pinch phase, as well as their various sub-phases—are generally known in the art and need not be described in detail herein other than to facilitate an understanding of the present techniques (see, e.g., [1, 3]).

The method 200 of FIG. 4 include a step 202 of operating a plasma focus device 102, such as the one depicted in FIG. 2, to emit primary neutrons 106 and a remnant ion beam 108 including beam ions 110. As noted above, in some embodiments, the plasma focus device 102 may be configured to emit a remnant ion beam 108 without primary neutron emission. The plasma focus device 102 can include an electrode assembly 112 having an inner electrode 130 and an outer electrode 132. The inner electrode 130 extends along a pinch axis 138 between a discharge end 140 and a focus end 142. The outer electrode 132 surrounds the inner electrode 130 and defines therebetween a plasma channel 134. For example, the outer electrode 132 can enclose the inner electrode 130 in a coaxial arrangement with respect to the pinch axis 138.

The step 202 of operating the plasma focus device 102 of FIG. 2 can include a step of supplying a process gas 136 inside the plasma channel 134 formed between the inner electrode 130 and the outer electrode 132. This step 202 can be performed by using a suitable process gas supply unit 118 to supply the process gas 136 into a vacuum chamber 116 housing at least part of the electrode assembly 112. As noted above, the process gas 136 can contain neutronic fusion fuel, such as pure deuterium or a mixture of deuterium and tritium. In some embodiments, the step of supplying the process gas 136 inside the plasma channel 134 can be performed over a time period ranging from about 1 second to about 100 seconds.

The step 202 of operating the plasma focus device 102 can also include a step of applying the discharge driving signal to the inner electrode 130 and the outer electrode 132. This step 202 can be performed by using a suitable power supply unit 114 that is part of, or coupled to, the plasma focus device 102. For example, the power supply unit 114 can be embodied by a pulsed-DC power supply including a capacitor bank and a switch. The application of the discharge driving signal causes the process gas 136 to be ionized and to form a plasma current sheath 158 inside the plasma channel 134, at the discharge ends 140, 144 of the electrodes 130, 132. The Lorentz force drives the plasma current sheath 58 down the plasma channel 134. Upon reaching the focus end 142 of the inner electrode 130, the plasma current sheath 158 radially collapses toward the pinch axis 138 to form a hot and dense plasma pinch 160. In some embodiments, the inner electrode 130 has a hollow interior at least at its focus end 142. The provision of a hollow interior allows the plasma pinch 160 to extend at least partly into the interior of the inner electrode 130.

During the pinch phase, instabilities and turbulences that occur within the plasma pinch 160 lead to the generation of the remnant ion beam 108 (e.g., a deuteron-triton beam if the process gas 136 contains a mixture of deuterium and tritium, a deuteron beam if the process gas 136 contains deuterium, or a triton beam if the process gas 136 contains tritium) and the primary neutrons 106 (e.g., from beam-target neutronic fusion reactions caused by accelerated fusion fuel ions colliding with fusion fuel ions of the plasma pinch 160). In some embodiments, the remnant ion beam 108 is emitted mainly along the pinch axis 138 in the forward direction, and the primary neutrons 106 are emitted almost isotopically with a slightly greater number in the forward direction. In some embodiments, the plasma pinch 160 can also generate an electron beam (not shown) emitted mainly along the pinch axis 138 in the rearward direction (i.e., in a direction opposite to that of the ion beam 108), as well as electromagnetic radiation (e.g., X-rays; not shown).

In some embodiments, the step of applying the discharge driving signal (e.g., by discharging the capacitor bank of the power supply unit 114 into the electrode assembly 112) can be performed over a time period ranging from about 1 microsecond to about 1 millisecond. In some embodiments, the step of applying the discharge driving signal can be initiated after a time delay ranging from about 1 millisecond to about 100 seconds after initiating the step of supplying the process gas 136 inside the plasma channel 134. In some embodiments, the step of applying the discharge driving signal can be repeated at longer intervals (e.g., the discharge driving signal is applied once every one minute to sixty minutes or longer, which can be referred to as a single-shot operation mode) or at shorter intervals (e.g., the discharge driving signal is applied once every ten milliseconds to ten seconds, which can be referred to as a repetitive-shot operation mode). In some embodiments, the processes going from the formation of the plasma current sheath 158 to the generation of the primary neutrons 106 and the ion beam 108 can occur over a time period ranging from about 1 microsecond to about 10 microseconds.

The neutron yield Y_{b-t(1)} of the primary neutrons 106 can be expressed as follows [3, 4], based on the interaction of beam ions 110 with a target plasma pinch 160 over an interaction distance equal to the pinch length zₚ:

$${Y}_{b - t ( 1 )} = {C}_{1} {n}_{i} {I}_{pinch}^{2} {z}_{p}^{2} ln ( \frac{b}{{r}_{p}} ) [ \frac{{σ}_{b - t} ( E )}{{E}^{1 / 2}} ] . \qquad ( 1 )$$

In Equation 1, C₁ is a calibration constant; nᵢ is the ion density in the plasma pinch 160; I_{pinch}, rₚ, and zₚ are the pinch current, radius, and length at the start of the slow compression phase, respectively; b is the radius of the outer electrode 132; σ_{b-t} is the beam-target fusion cross-section between the beam ions 110 and the fusion fuel ions in the plasma pinch 160; and E is the energy of the beam ions 110.

In general, only a relatively small proportion of the beam ions 110 undergo fusion collisions during their propagation through the plasma pinch 160. For example, a large 10-MA plasma focus device operating in D-T at 100 Torr and producing 10¹⁴ D-T neutrons per shot would have a Remnant beam ion number of the order of 10¹⁹ ions per shot. This means that about only one out of 10⁵ beam ions produced in the plasma pinch 160 generate fusion neutrons. The remaining beam ions 110 exit the plasma pinch 160 and are lost, thus amounting to a significant waste of fusion neutron production potential. The term “remnant” is used herein to refer to the fact that the ion beam 108 contains the beam ions 110 that have traveled through the plasma pinch 160 without undergoing fusion reactions.

Returning to FIG. 4, the method 200 includes a step 204 of providing a neutron source 104 including an enclosure 120 having a cavity 122 containing a target medium (e.g., a target gas 124 in FIG. 2). The method 200 also includes a step 206 of allowing at least part of the remnant ion beam 108 to enter and travel inside the cavity 122. As the ion beam 108 travels inside the cavity 122, the beam ions 110 interact with the target medium and undergo both fusion and non-fusion collisions. The fusion collisions produce neutrons 128 (e.g., secondary neutrons 128 if the plasma focus device 102 produces primary neutrons 106) and reduce a number of the beam ions 110 within the ion beam 108. The non-fusion collisions reduce the energy E of the beam ions 110. The neutron source 104 is thus configured to harvest at least part of the remnant ion beam 108 emanating from the plasma pinch 160 and to produce neutrons 128 from the remnant beam ions 110. When the plasma focus device 102 produces primary neutrons 106, the secondary neutrons 128 add to the primary neutrons 106 to increase the total neutron yield of the plasma focus system 100. The neutron source 104 also includes a beam entrance port 126 configured to allow at least part of the remnant ion beam 108 to enter and travel inside the cavity 122. It is noted that even if only a relatively small fraction (e.g., about 10%) of the total number of beam ions 110 emanating from the plasma pinch 160 (e.g., about 10¹⁹) ultimately enters inside the cavity 122, this number (e.g., about 10¹⁸) can still be substantial for neutron yield enhancement purposes.

In the embodiment of FIG. 2, the enclosure 120 has a tubular body extending along an enclosure axis 162 between a first enclosure end 164 proximal to the plasma focus device 102 and a second enclosure end 166 distal from the plasma focus device 102. In the illustrated embodiment, the enclosure axis 162 is coaxial with the pinch axis 138 of the electrode assembly 112, but this is not a requirement. The enclosure 120 may be embodied by any suitable pressure vessel, for example, a cylindrical tank made of stainless steel or another suitable material. In some embodiments, the enclosure 120 has a length ranging from about 50 cm to about 2 m, and a diameter ranging from about 2 cm to about 50 cm. In the illustrated embodiment, the enclosure 120 has a circular cross-section, although non-circular cross-section (e.g., square or rectangular) are possible in other embodiments. In some embodiments, the separation distance between the focus end 142 of the inner electrode 130 and the first enclosure end 164 of the enclosure 120 can range from about 4 cm to about 60-120 cm, although other separation distance values can be used in other embodiments. In some embodiments, the separation distance can be established based on the radius of the inner electrode 130. For example, in some embodiments, the separation distance between the forward end of the plasma pinch 160 and the first enclosure end 164 can be selected to be of the order of about four times the radius of the inner electrode 130. It is appreciated that the separation distance can be selected so as to be large enough to avoid disturbing the formation of the plasma pinch 160, but short enough to maximize or at least increase the fraction of the remnant ion beam 108 entering the cavity 122 through the beam entrance port 126.

In the illustrated embodiment, the beam entrance port 126 is provided at the first enclosure end 164, so that the remnant ion beam 108 entering inside the cavity 122 via the beam entrance port 126 is configured to travel mainly axially along the cavity 122, from the first enclosure end 164 toward to second enclosure end 166. In some embodiments, the beam entrance port 126 has a diameter ranging from about 1 cm to about 10 cm. Depending on the application, the surface area of the beam entrance port 126 may be substantially equal to or less than the surface area of the first enclosure end 164. In some embodiments, the beam entrance port 126 can include a beam entrance window 176 made of molybdenum, beryllium, tungsten, biaxially-oriented polyethylene terephthalate (BoPET, often known by its trade name Mylar®), or another suitable material (e.g. a metallic, ceramic, or composite material) through which the remnant ion beam 108 can be transmitted without appreciable or significant attenuation or scattering. In some embodiments, the beam entrance window 176 has a thickness ranging from about 100 μm to about 500 μm, although other window thickness values can be used in other embodiments.

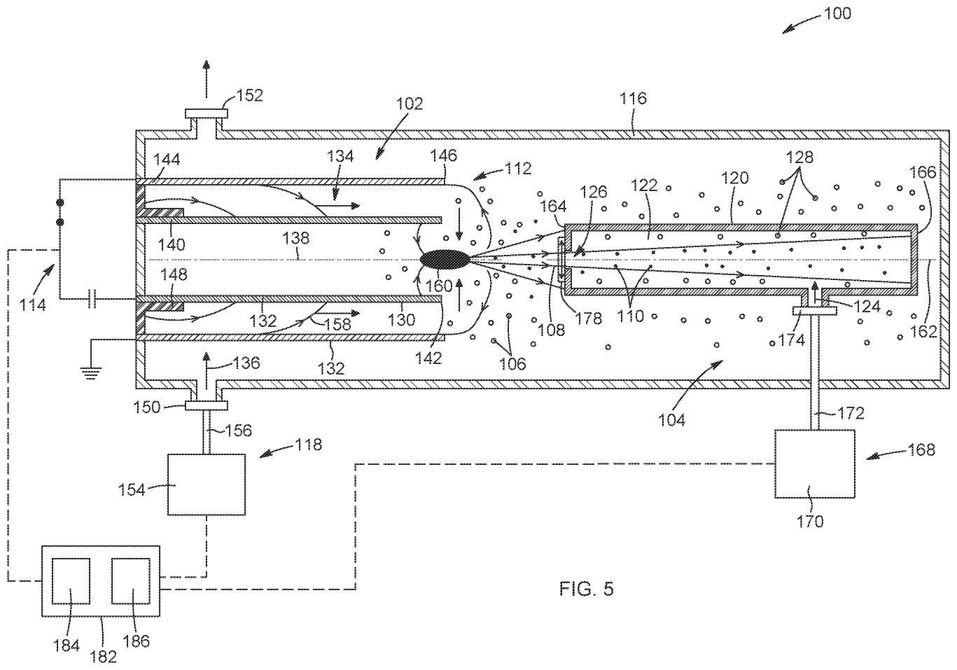

Referring briefly to FIG. 5, in other embodiments, the beam entrance port 126 can include a beam shutter 178 movable between a closed shutter position, in which the target gas 124 is scaled within the enclosure 120 and the remnant ion beam 108 is prevented from entering the cavity 122, and an open shutter position, in which the remnant ion beam 108 is allowed to enter inside the cavity 122 and interact with the target gas 124. In such embodiments, the beam shutter 178 can be located at the first enclosure end 164 so as to intercept the ion beam path. In some embodiments, the beam shutter 178 is a fast shutter with a short opening and closing time (e.g., of the order of one millisecond), so as to minimize or at least reduce the amount of the target gas 124 escaping from within the cavity 122 in the open shutter position. It is appreciated that the operation of the beam shutter 178 can be coordinated with the operation of the plasma focus device 102 to ensure that the period during which the beam shutter 178 is in the open shutter position overlap over a sufficiently long time with the period during which the remnant ion beam 108 emitted from the plasma pinch 160 impinges on the beam entrance port 126.

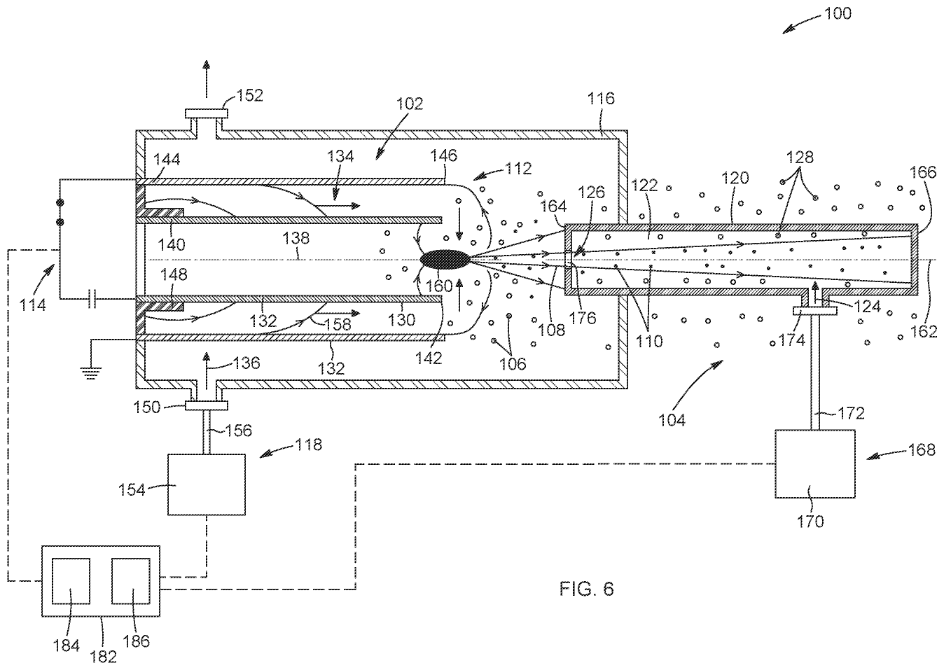

Returning to FIG. 2, in the illustrated embodiment, the enclosure 120 is disposed inside the vacuum chamber 116 of the plasma focus device 102, although this is not a requirement. In other embodiments, the enclosure 120 may be disposed fully or partially outside the vacuum chamber 116. For example, referring to FIG. 6, the first enclosure end 164 (including the beam entrance port 126) may be disposed inside the vacuum chamber 116, while the second enclosure end 166 may be disposed outside the vacuum chamber 116.

Returning to FIG. 2, in some embodiments, the cavity 122 is pressure-sealed from the surrounding pressure environment of the vacuum chamber 116. This allows the fill pressure of the target gas 124 inside the cavity 122 to be different from the fill pressure of the process gas 136 inside the vacuum chamber 116. In some embodiments, the fill pressure of the target gas 124 inside the cavity 122 can range from about 2 atm to about 6 atm. which is higher than the exemplary fill pressure range given above for the process gas 136 inside the vacuum chamber 116.

In some embodiments, the neutron source 104 can include a target gas supply unit 168, which can include, or be coupled to, a target gas source 170 configured to store the target gas 124. The target gas source 170 can be embodied by a gas storage tank or any suitable pressurized dispensing container. In some embodiments, a single gas storage container may embody both the target gas source 170 and the process gas source 154. The target gas supply unit 168 can also include a target gas supply line 172 connected between the target gas source 172 and a target gas inlet port 174 formed in the enclosure 120. The target gas supply line 172 is configured to allow the target gas 124 to enter and fill the cavity 122. The target gas supply unit 168 can also include various additional flow control devices (not shown), for example, valves, pumps, regulators, and restrictors, configured to control the introduction of the target gas 124 inside the enclosure 120. It is appreciated that various configurations and arrangements are contemplated for the target gas supply unit 168, and that various gas injection techniques can be used.

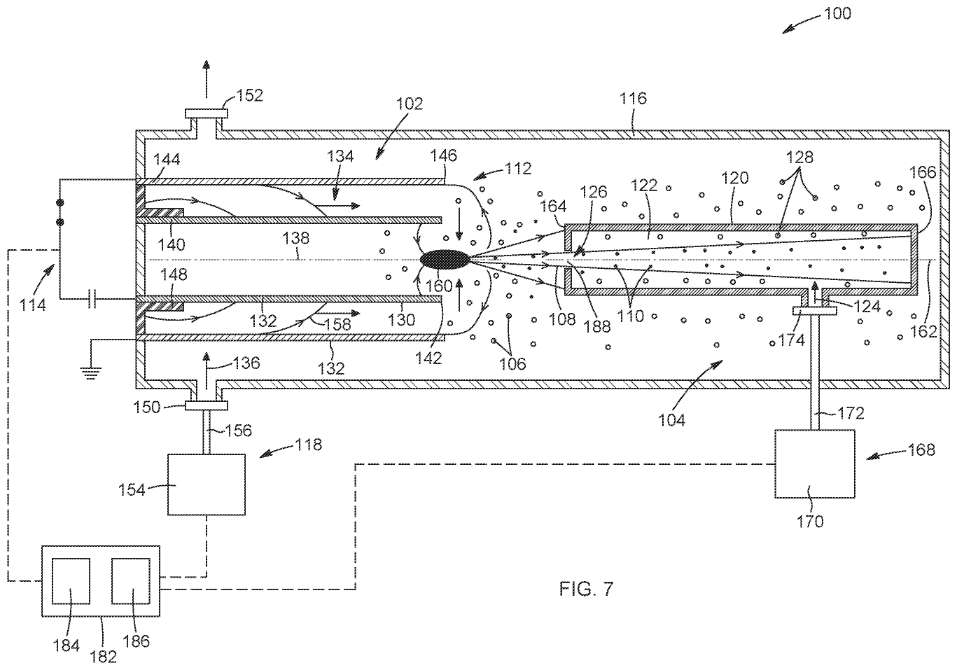

In some embodiments, the target gas supply unit 168 can include a plurality of gas puff valves (not shown) controlled by a valve driving circuit and configured to inject the target gas 124 inside the cavity 122 as high-density gas pulses (e.g., at 100 psi or more). Referring to FIG. 7, in such embodiments, the beam entrance port 126 can be embodied by a through-opening 188 formed in the first enclosure end 164, such that the enclosure 120 is an open-ended tube in gas communication with the interior of the vacuum chamber 116. In such embodiments, the operation of the gas puff valves can be coordinated with the operation of the plasma focus device 102 to ensure that the injection of the target gas 124 occurs only shortly before the remnant ion beam 108 enters the cavity 122. For example, in some embodiments, the injection of the target gas 124 can be initiated about one millisecond or less before the plasma pinch 160 is formed. It is appreciated that in embodiments where the cavity 122 is in gas communication with the interior of the vacuum chamber 116, the injection of the target gas 124 may increase the pressure inside the vacuum chamber 116 to unacceptable levels (e.g., higher than 1.5 atm). In order to mitigate overpressure risks, the vacuum chamber 116 can be equipped with pressure relief valves (not shown) configured to release pressure from the interior of the vacuum chamber 116 if a threshold pressure level is reached.

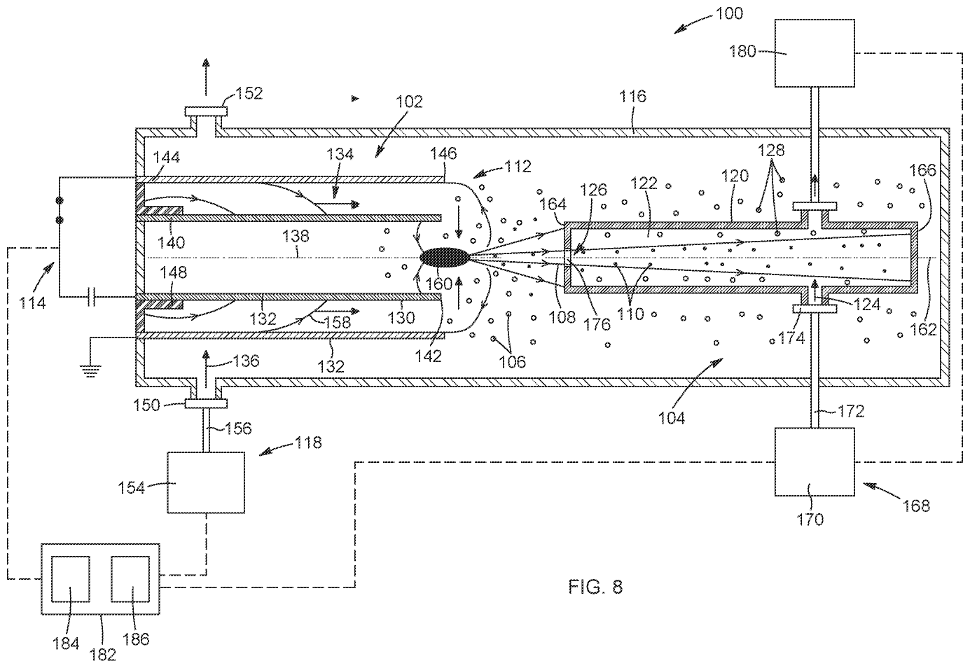

Referring to FIG. 8, in some embodiments, the vacuum chamber 116 can also include a target gas recycling unit 180 configured to recover at least part of the remaining target gas 124 after interaction with the remnant ion beam 108. The provision of a target gas recycling unit 180 can be advantageous when the target gas 124 is composed of a deuterium-tritium mixture due to the high cost of tritium.

Returning to FIG. 2, the composition of the target gas 124 can be the same as that of the process gas 136, but this is not a requirement. In some embodiments, both the target gas 124 and the process gas 136 can be composed of deuterium, while in other embodiments, both the target gas 124 and the process gas 136 can be composed of a mixture of deuterium and tritium (with either the same or different proportions of deuterium and tritium). In yet other embodiments, the target gas 124 can include another suitable neutronic fusion fuel. It is appreciated that using the same fusion fuel in both the target gas 124 and the process gas 136 can be advantageous or required for the beam ions 110 emitted by the plasma pinch 160 to undergo neutronic fusion reactions with the target gas 124 and produce the secondary neutrons 128. In other embodiments, the target gas 124 and the process gas 136 may have different compositions. For example, the target gas 124 can be composed of tritium and the process gas 136 can be composed of deuterium, or vice versa.

In some embodiments, the process gas 136 includes a mixture of deuterium and tritium (e.g., a 50-50 deuterium-tritium mixture), the beam ions 110 include deuterons and tritons, the target gas 124 includes a mixture of deuterium and tritium (e.g., a 50-50 deuterium-tritium mixture), and the secondary neutrons 128 are produced by the D-T fusion reaction. In other embodiments, the process gas 136 includes deuterium, the beam ions 110 include deuterons, the target gas 124 includes deuterium, and the secondary neutrons 128 are produced by the D-D fusion reaction. In yet other embodiments, the process gas 136 includes deuterium, the beam ions 110 include deuterons, the target gas 124 includes tritium, and the secondary neutrons 128 are produced by the D-T fusion reaction. In still other embodiments, the process gas 136 includes tritium, the beam ions 110 include tritons, the target gas 124 includes deuterium, and the neutrons 128 are produced by the D-T fusion reaction (without primary neutron emission from the plasma focus device 102).

In some embodiments, the neutron yield Y_{b-t(2)} of the secondary neutrons 128 can be expressed by modifying Equation (1) for Y_{b-t(1)} as follows:

$${Y}_{b - t ( 2 )} = {C}_{2} {n}_{eff} {I}_{pinch}^{2} {z}_{p} {L}_{eff} ln ( \frac{b}{{r}_{p}} ) [ \frac{{σ}_{b - t} ( E )}{{E}^{1 / 2}} ] . \qquad ( 2 )$$

In Equation (2), C₂ is a calibration constant; n_{eff} is the atomic density in the target gas 124; I_{pinch}, rₚ, and zₚ are the pinch current, radius, and length at the start of the slow compression phase, respectively; L_{eff} is the effective length traveled by the beam ions 110 through the target gas 124; b is the radius of the outer electrode 132; σ_{b-t} is the beam-target fusion cross-section between the beam ions 110 and the fusion fuel ions in the target gas 124; and E is the energy of the beam ions 110.

As noted above, in large plasma focus devices operating in D-T, which is currently the most widely used fusion fuel, the energy of the remnant ion beam 108 responsible for producing the primary neutrons 106 within the plasma pinch 160 generally far exceeds the energy Eₘₐₓ≈115 keV at which the beam-target fusion cross-section σ_{b-t} is maximum, resulting in suboptimal neutron yield. In the present techniques, the remnant ion beam 108 enters and travels inside the cavity 122 to interact with the target gas 124. These interactions include both fusion and non-fusion collisions. The fusion collisions produce the secondary neutrons 128 and gradually reduce the number of beam ions 110 in the remnant ion beam 108, while non-fusion collisions gradually reduce the energy E of the beam ions 110. Due to the non-fusion collisions, the fusion collisions between beam ions 110 and the target gas 124 occur at progressively lower beam ion energies E as the ion beam 108 travels inside the cavity 122. In the case of the D-T reaction, the fusion cross-section or σ_{b-t}(E) of the fusion reactions increases progressively as the beam traveling distance inside the cavity 122 increases, eventually reaching a maximum if E reaches Eₘₐₓ≈115 keV, and likewise for the secondary neutron yield Y_{b-t(2)}, as per Equation (2). It is appreciated that the length of the enclosure 120 and/or the density of the target gas 124 can be controlled so that the beam energy E decreases sufficiently to reach Eₘₐₓ before the ion beam 108 reaches the second enclosure end 166. Further propagation inside the cavity 122 will further reduce the beam energy E until the progressively weakening collisions no longer produce significant fusion events.

In some embodiments, as the remnant ion beam 108 travels along the cavity 122, the non-fusion collisions can gradually reduce the energy of the beam ions 110 from a first energy range to a second energy range, wherein the beam-target fusion cross-section σ_{b-t}(E) between the beam ions 110 and the target gas 124 increases from within the first energy range to within the second energy range, thereby causing the fusion collisions to produce the secondary neutrons 128 with a gradually increasing value of the secondary neutron yield Y_{b-t(2)}. In some embodiments, the first energy range extends from about 1 MeV to about 20 MeV, and the second energy range extends from about 50 keV to about 200 keV, or even from about 1 keV to about 200 keV. In some embodiments, the second energy range encompasses a maximum in the beam-target fusion cross-section σ_{b-t}(E) between the beam ions 110 and the target gas 124.

Returning to Equation (2), it is appreciated that three different factors can contribute to enhancing the secondary neutron yield Y_{b-t(2)}: (i) the density n_{eff} of the target gas 124; (ii) the reduction in beam ion energy E and the corresponding increase in the beam target fusion cross-section σ_{b-t}(E) in the parameter σ_{b-t}(E)/E^{1/2} appearing in Equation (2); and (iii) the interaction distance L_{eff} between the remnant ion beam 108 and the target gas 124. In some embodiments, these three factors can be controlled by adjusting the operation of the plasma focus device 102 (to control the energy of the beam ions 110 entering the enclosure 120) and by adjusting density of the target gas 124 and the length of the cavity 122. In some embodiments, by proper adjustment of these three factors, the ratio Y_{b-t(2)}/Y_{b-t(1)} of the secondary neutron yield Y_{b-t(2)} to the primary neutron yield Y_{b-t(1)} can range from about 100 to about 100,000. In such embodiments, such a gain would make the secondary neutron yield Fran the major fusion harvest, so that the secondary neutron source 104 could be referred to as a fusion harvester. For example, in some embodiments, the first factor (or pressure factor) can increase Y_{b-t(2)} relative to Y_{b-t(1)} by an amount ranging from about 10 to about 100; the second factor (or cross-section factor) can increase Y_{b-t(2)} relative to Han by an amount ranging from about 10 to about 1,000, and the third factor (or interaction path factor) can increase Y_{b-t(2)} relative to Y_{b-t(1)} by an amount ranging from about 5 to about 100.

It is appreciated that the provision of the neutron source 104 described herein can be advantageous in high-current plasma focus devices operating in D-T, due to the increase in Y_{b-t(2)} resulting from the second factor, that is, the gradual increase in σ_{b-t}(E) caused by the gradual decrease in E toward Eₘₐₓ with increasing ion beam traveling distance within the cavity 122. However, the neutron source 104 can also be useful in various other implementations in which the effect of the second factor on Y_{b-t(2)} is absent, negligible, or simply not predominant compared to the effect of the first and/or the third factor. Non-limiting examples of such other embodiments can include small plasma focus systems operated in D-T, as well as both small and large plasma focus systems not operated in D-T. For example, returning to FIG. 1, it is seen that the beam-target fusion cross-section σ_{b-t}(E) for the D-D reaction (1) increases by about one order of magnitude when E decreases from about 10 MeV to about 5 MeV, resulting in a similar increase in the parameter σ_{b-t}(E)/E^{1/2}, and (2) decreases by about one order of magnitude when E decreases from about 5 MeV to about 100 keV, resulting in a nearly constant value of the parameter σ_{b-t}(E)/E^{1/2}. Thus, in the case of plasma focus systems operated in D-D, the enhancement of the secondary neutron yield Y_{b-t(2)} would be expected to occur predominantly through the effect of the first and/or the third factor, rather than due to the second factor. In such embodiments, the provision of the neutron source 104 as a fusion harvester could still increase the total neutron yield of the system 100 by a significant amount.

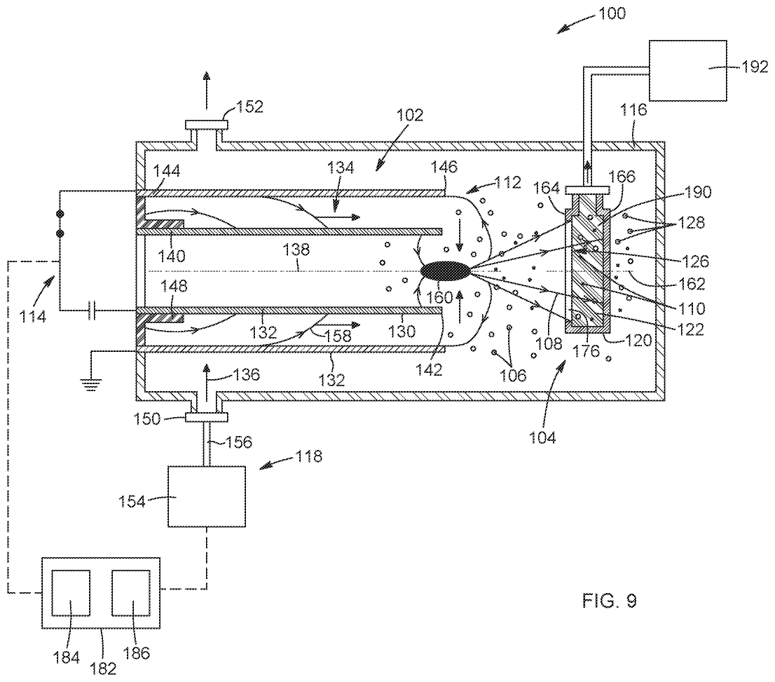

Although several embodiments described use a gas as the target medium provided in the enclosure of the neutron source, other embodiments can use a solid or a liquid as the target medium. Referring to FIG. 9, there is illustrated another embodiment of a plasma focus system 100 used for enhanced neutron production. The embodiment of FIG. 9 shares several similar features with the embodiment of FIG. 2, which will not be described again in detail other than to highlight differences between them. The plasma focus system 100 of FIG. 9 generally includes a plasma focus device 102 and a neutron source 104. The plasma focus device 102 is configured to emit primary neutrons 106 and a remnant ion beam 108 including beam ions 110. In the illustrated embodiment, the plasma focus device 102 generally includes an electrode assembly 112, a power supply unit 114, a vacuum chamber 116, and a process gas supply unit 118. The neutron source 104 includes an enclosure 120 having a cavity 122 formed therein for receiving a target medium. In the illustrated embodiment, the target medium is a target solid 190. The neutron source 104 also includes a beam entrance port 126 configured to allow at least part of the ion beam 108 to enter and travel inside the cavity 122, where the beam ions 110 can interact with the target gas 124 via both fusion and non-fusion collisions. The fusion collisions produce neutrons 128, which in this embodiment will be referred to as secondary neutrons. The secondary neutrons 128 add to the primary neutrons 106 emitted by the plasma focus device 102 to increase the total neutron yield of the plasma focus system 100.

In some embodiments, the target solid 190 can be composed of heavy ice (D₂O), super-heavy ice (T₂O), or a mixture of heavy ice (D₂O) and super-heavy ice (T₂O). In some embodiments, the process gas 136 includes a mixture of deuterium and tritium (e.g., a 50-50 deuterium-tritium mixture), the beam ions 110 include deuterons and tritons, the target solid 190 includes a mixture of D₂O ice and TO ice (e.g., a 50-50 mixture of D₂O ice and T₂O ice), and the secondary neutrons 128 are produced by the D-T fusion reaction. In other embodiments, the process gas 136 includes deuterium, the beam ions 110 include deuterons, the target solid 190 includes D₂O ice, and the secondary neutrons 128 are produced by the D-D fusion reaction. In yet other embodiments, the process gas 136 includes deuterium, the beam ions 110 include deuterons, the target solid 190 includes T₂O ice, and the secondary neutrons 128 are produced by the D-T fusion reaction. In still other embodiments, the process gas 136 includes tritium, the beam ions 110 include tritons, the target solid 190 includes D₂O ice, and the neutrons 128 are produced by the D-T fusion reaction (without primary neutron emission from the plasma focus device 102).

As for target gas embodiments, the enclosure 120 in FIG. 9 may be embodied by any suitable pressure vessel, for example, a cylindrical tank made of stainless steel or another suitable material. It is noted, however, that the since the density of D₂O or T₂O ice is significantly larger than the density of D or T gas (e.g., the density of D₂O or T₂O ice can be about 200 times more than the density of D or T gas at 6 atm), the enclosure 120 in the embodiment of FIG. 9 can be significantly shorter than in embodiments where the target medium is a target gas (see, e.g., FIGS. 2 and 4 to 8) and still produce the same beam interaction and energy reduction effect for neutron yield enhancement. For example, in some embodiments, the enclosure 120 can have a length ranging from about 5 mm to about 20 mm. In some embodiments, the enclosure 120 can have lateral dimensions ranging from about 2 cm to about 60 cm. In some embodiments, the separation distance between the focus end 142 of the inner electrode 130 and the first enclosure end 164 of the enclosure 120 can range from about 4 cm to about 60-120 cm. In some embodiments, the lateral dimensions and the separation distance of the enclosure 120 can be established based on the radius of the inner electrode 130. For example, in some embodiments, the lateral dimensions of the enclosure 120 can be selected to be of the order of about two times the radius of the inner electrode 130, and the separation distance can be selected to be of the order of about four times the radius of the inner electrode 130. The lateral dimensions can be selected to allow most of the remnant ion beam 108 to be intercepted, while still keeping the size of the enclosure 120 reasonable. It is noted that increasing the lateral dimensions beyond a certain point will hardly increase the amount of remnant beams ions 110 entering the cavity 122. It is also generally recognized in the art that remnant ion beams in plasma focus devices are mostly confined to the central 20 degrees (full angle) and generally few remnant ion beam ions are emitted beyond about this range. The separation distance can be selected so as to be large enough to avoid disturbing the formation of the plasma pinch 160, but short enough to maximize or at least increase the fraction of the remnant ion beam 108 entering the cavity 122 through the beam entrance port 126.

In some embodiments, the beam entrance port 126 may be configured to occupy most of the surface area of the first enclosure end 164 for enhancing beam ion capture, although this is not a requirement. In FIG. 9, the beam entrance port 126 includes a beam entrance window 176, which can be made of molybdenum, beryllium, tungsten. BoPET, or another suitable material through which the remnant ion beam 108 can be transmitted without significant attenuation or scattering. In other embodiments, the beam entrance port 126 can include a beam shutter movable between a closed shutter position, the remnant ion beam 108 is prevented from entering the cavity 122, and an open shutter position, in which the remnant ion beam 108 is allowed to enter inside the cavity 122 and interact with the target solid 190. As for target embodiments, the operation of the beam shutter can be coordinated with the operation of the plasma focus device 102 to ensure that the period during which the beam shutter is in the open shutter position overlap over a sufficiently long time with the period during which the remnant ion beam 108 emitted from the plasma pinch 160 impinges on the beam entrance port 126.

In some embodiments, the process of inserting the target solid 190 inside the enclosure 120 can include steps of pouring the target material in liquid form (e.g., as heavy water, super-heavy water, or a mixture thereof) into the enclosure 120, freezing the target material into a solid (e.g., in a freezing device), and transporting the enclosure 120 into its operating position (e.g., inside the vacuum chamber 116 of the plasma focus device 102). In some embodiments, a temperature controller (not shown) may be coupled to the enclosure 120 to keep the target solid 190 at a specified target temperature during neutron production. For example, when the target solid 190 is composed of D₂O ice (freezing point: 3.8° C.) and/or T₂O ice (freezing point: 4.5° C.), the target temperature can range from about 0° C. to about 2° C. It is appreciated that the enclosure 120 (including the beam entrance window 176) can serve to contain, protect, and thermally insulate the target solid 190.

In some embodiments, the neutron source 104 can include a waste-gas venting unit 192 configured to release waste gas produced from beam-target fusion reactions from the enclosure 120, as substantial amounts of waste gas could otherwise accumulate in the enclosure 120 after a number of discharges. Non-limiting examples of waste gas that can be produced during beam-target fusion reactions with D₂O and T₂O targets include helium and hydrogen (the latter from the proton branch of the D-D reaction).

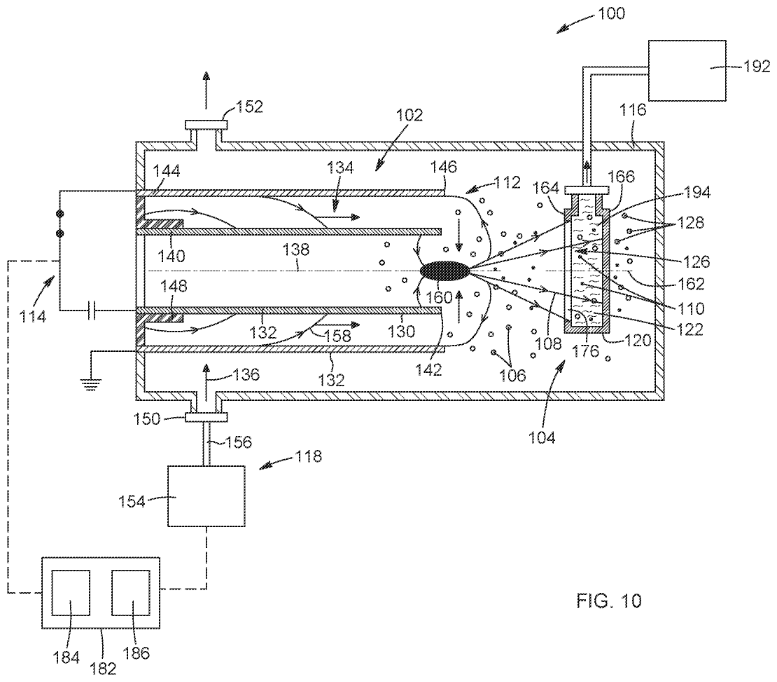

Referring to FIG. 10, there is illustrated another embodiment of a plasma focus system 100 used for enhanced neutron production. The embodiment of FIG. 10 shares several similar features with the embodiment of FIG. 9, which will not be described again in detail, but differs at least in that the target medium is a target liquid 194. In some embodiments, the target liquid 194 can be composed of heavy water (D₂O), super-heavy water (T₂O), or a mixture of heavy water (D₂O) and super-heavy water (T₂O). In some embodiments, the process gas 136 includes a mixture of deuterium and tritium (e.g. a 50-50 deuterium-tritium mixture), the beam ions 110 include deuterons and tritons, the target liquid 194 includes a mixture of D₂O water and T₂O water (e.g., a 50-50 mixture of D₂O water and T₂O water), and the secondary neutrons 128 are produced by the D-T fusion reaction. In other embodiments, the process gas 136 includes deuterium, the beam ions 110 include deuterons, the target liquid 194 includes D₂O water, and the secondary neutrons 128 are produced by the D-D fusion reaction. In yet other embodiments, the process gas 136 includes deuterium, the beam ions 110 include deuterons, the target liquid 194 includes T₂O water, and the secondary neutrons 128 are produced by the D-T fusion reaction. In still other embodiments, the process gas 136 includes tritium, the beam ions 110 include tritons, the target liquid 194 includes D₂O water, and the neutrons 128 are produced by the D-T fusion reaction (without primary neutron emission from the plasma focus device 102).

In FIG. 10, the beam entrance port 126 includes a beam entrance window 176, but other embodiments can include a beam shutter, as discussed above with respect to target gas and target solid embodiments. It appreciated that to facilitate the use of a beam shutter in the case of a target liquid 194 (e.g., to avoid spillage of the target liquid 194 from the enclosure 120 when the beam shutter is open), the plasma focus device 102 may be arranged vertically, with the ion beam 108 propagating downward (i.e., along the direction of gravity).

Returning to FIG. 2, the plasma focus system 100 can further include a control and processing unit 182 configured to control, monitor, and/or coordinate the functions and operations of various system components, including the power supply unit 114, the vacuum chamber 116, the process gas supply unit 118, the enclosure 120, the target gas supply unit 168, as well as various temperature, pressure, flow rate, and power conditions. In particular, the control and processing unit 182 may be configured to synchronize or otherwise time-coordinate the functions and operations of various components of the plasma focus system 100. The control and processing unit 182 can be implemented in hardware, software, firmware, or any combination thereof, and be connected to various components of the plasma focus system 100 via wired and/or wireless communication links to send and/or receive various types of signals, such as timing and control signals, measurement signals, and data signals. The control and processing unit 182 may be controlled by direct user input and/or by programmed instructions, and may include an operating system for controlling and managing various functions of the plasma focus system 100. Depending on the application, the control and processing unit 182 may be fully or partly integrated with, or physically separate from, the other hardware components of the plasma focus system 100. The control and processing unit 182 can include a processor 184 and a memory 186.

The processor 184 can implement operating systems, and may be able to execute computer programs, also known as commands, instructions, functions, processes, software codes, executables, applications, and the like. While the processor 184 is depicted in FIG. 2 as a single entity for illustrative purposes, the term “processor” should not be construed as being limited to a single processing entity, and accordingly, any known processor architecture may be used. In some embodiments, the processor 184 may include a plurality of processing entities. Such processing entities may be physically located within the same device, or the processor 184 may represent the processing functionalities of a plurality of devices operating in coordination. For example, the processor 184 may include or be part of one or more of a computer; a microprocessor; a microcontroller; a coprocessor; a central processing unit (CPU); a special-purpose programmable logic device embodied in hardware device, such as, for example, a field-programmable gate array (FPGA) or an application-specific integrated circuit (ASIC); a digital processor: an analog processor; and/or other mechanisms configured to electronically process information and to operate collectively as a processor.

The memory 186, which may also be referred to as a “computer readable storage medium” or a “computer readable memory” is configured to store computer programs and other data to be retrieved by the processor 184. The terms “computer readable storage medium” and “computer readable memory” refer herein to a non-transitory and tangible computer product that can store and communicate executable instructions for the implementation of various steps of the techniques disclosed herein. The memory 186 may be any computer data storage device or assembly of such devices, including a random-access memory (RAM); a dynamic RAM; a read-only memory (ROM); a magnetic storage device; an optical storage device; a flash drive memory; and/or any other non-transitory memory technologies. The memory 186 may be associated with, coupled to, or included in the processor 184, and the processor 184 may be configured to execute instructions contained in a computer program stored in the memory 186 and relating to various functions and operations associated with the processor 184. While the memory 186 is depicted in FIG. 2 as a single entity for illustrative purposes, the term “memory” should not be construed as being limited to a single memory unit, and accordingly, any known memory architecture may be used. In some embodiments, the memory 186 may include a plurality of memory units. Such memory units may be physically located within the same device, or the memory 186 can represent the functionalities of a plurality of devices operating in coordination.

The plasma focus system 100 may also include one or more user interface devices (not shown) operatively connected to the control and processing unit 182 to allow the input of commands and queries to the plasma focus system 100, as well as present the outcomes of the commands and queries. The user interface devices can include input devices (e.g., a touch screen, a keypad, a keyboard, a mouse, a switch, and the like) and output devices (e.g., a display screen, a printer, visual and audible indicators and alerts, and the like).

The following aspects are also disclosed herein:

1. A plasma focus system for neutron production, the plasma focus system comprising:
a plasma focus device configured to emit a remnant ion beam comprising beam ions; and
a neutron source comprising an enclosure having a cavity formed therein for receiving a target medium, the enclosure comprising a beam entrance port configured to allow at least part of the remnant ion beam to enter and travel inside the cavity.
wherein, as the remnant ion beam travels along the cavity, the beam ions interact with the target medium and undergo fusion collisions, which produce neutrons and reduce a number of the beam ions, and non-fusion collisions, which reduce an energy of the beam ions.
   2. The plasma focus system of aspect 1, wherein, as the remnant ion beam travels inside the cavity, the non-fusion collisions gradually reduce the energy of the beam ions from a first energy range to a second energy range, and wherein a beam-target fusion cross-section between the beam ions and the target medium increases from within the first energy range to within the second energy range, thereby causing the fusion collisions to produce the neutrons with a gradually increasing neutron yield.
   3. The plasma focus system of aspect 2, wherein the first energy range extends from about 1 MeV to about 20 MeV, and wherein the second energy range extends from about 1 keV to about 200 keV.
   4. The plasma focus system of aspect 2 or 3, wherein the second energy range encompasses a maximum in the beam-target fusion cross-section between the beam ions and the target medium.
   5. The plasma focus system of aspect 4, wherein the maximum in the beam-target fusion cross-section between the beam ions and the target medium is at a beam ion energy of about 115 keV.
   6. The plasma focus system of any one of aspects 1 to 5, wherein the beam ions comprise deuterons and tritons, the target medium comprises a mixture of deuterium and tritium, and the neutrons are produced by the D-T fusion reaction.
   7. The plasma focus system of any one of aspects 1 to 5, wherein the beam ions comprise deuterons, the target medium comprises tritium, and the neutrons are produced by the D-T fusion reaction.
   8. The plasma focus system of any one of aspects 1 to 5, wherein the beam ions comprise deuterons, the target medium comprises deuterium, and the neutrons are produced by the D-D fusion reaction.
   9. The plasma focus system of any one of aspects 1 to 5, wherein the beam ions comprise tritons, the target medium comprises deuterium, and the neutrons are produced by the D-T fusion reaction.
   10. The plasma focus system of any one of aspects 1 to 8, wherein the plasma focus device further emits primary neutrons, and wherein the neutrons produced by the neutron source correspond to secondary neutrons.
   11. The plasma focus system of any one of aspects 1 to 10, wherein the enclosure extends between a first enclosure end, proximal to the plasma focus device, and a second enclosure end distal from the plasma focus device, and wherein the beam entrance port is provided at the first enclosure end.
   12. The plasma focus system of any one of aspects 1 to 11, wherein the beam entrance port comprises a beam entrance window.
   13. The plasma focus system of any one of aspects 1 to 11, wherein the beam entrance port comprises a beam shutter, wherein the beam shutter is movable between a closed shutter position, wherein the remnant ion beam is prevented from entering the cavity, and an open shutter position, wherein the remnant ion beam is allowed to enter inside the cavity.
   14. The plasma focus system of any one of aspects 1 to 13, wherein the target medium is a target gas.
   15. The plasma focus system of aspect 14, wherein the target gas comprises deuterium, tritium, or a mixture of deuterium and tritium.
   16. The plasma focus system of aspect 14 or 15, wherein a fill pressure of the target gas inside the cavity ranges from about 2 atm to about 6 atm.
   17. The plasma focus system of any one of aspects 14 to 16, wherein the enclosure has a length ranging from about 50 cm to about 2 m.
   18. The plasma focus system of any one of aspects 1 to 13, wherein the target medium is a target solid.
   19. The plasma focus system of aspect 18, wherein the target solid comprises D₂O ice, T₂O ice, or a mixture of D₂O ice and T₂O ice.
   20. The plasma focus system of aspect 18 or 19, wherein the enclosure has a length ranging from about 5 mm to about 20 mm.
   21. The plasma focus system of any one of aspects 1 to 13, wherein the target medium is a target liquid.
   22. The plasma focus system of aspect 21, wherein the target liquid comprises D₂O water, T₂O water, or a mixture of D₂O water and T₂O water.
   23. The plasma focus system of aspect 21 or 22, wherein the enclosure has a length ranging from about 5 mm to about 20 mm.
   24. The plasma focus system of any one of aspects 1 to 23, wherein the plasma focus device comprises:
an electrode assembly comprising:
   an inner electrode extending along a pinch axis between a discharge end and a focus end; and
   an outer electrode surrounding the inner electrode and defining therebetween a plasma channel configured to receive a process gas; and
a power supply unit configured to apply a discharge driving signal to the inner electrode and the outer electrode, wherein applying the discharge driving signal causes the process gas to be ionized into a plasma current sheath at the discharge end and the plasma current sheath to flow along the plasma channel and reach the focus end where the plasma current sheath collapses toward the pinch axis to form a plasma pinch from which the remnant ion beam is emitted.
   25. The plasma focus system of aspect 24, wherein the enclosure extends along an enclosure axis that is coaxial with respect to the pinch axis.
   26. The plasma focus system of aspect 24 or 25, wherein the plasma focus device comprises a vacuum chamber configured to contain the process gas therein and to house at least part of the enclosure, including the beam entrance port.
   27. The plasma focus system of any one of aspects 24 to 26, wherein the process gas comprises deuterium, tritium, or a mixture of deuterium and tritium.
   28. A plasma focus method of neutron production, the method comprising:
operating a plasma focus device to emit a remnant ion beam comprising beam ions;
providing a neutron source comprising an enclosure having a cavity with a target medium thereinside; and
allowing at least part of the remnant ion beam to enter and travel inside the cavity, wherein, as the remnant ion beam travels inside the cavity, the beam ions interact with the target mediums and undergo fusion collisions, which produce neutrons and reduce a number of the beam ions, and non-fusion collisions, which reduce an energy of the beam ions.
   29. The plasma focus method of aspect 28, wherein, as the remnant ion beam travels inside the cavity, the non-fusion collisions gradually reduce the energy of the beam ions from a first energy range to a second energy range, and wherein a beam-target fusion cross-section between the beam ions and the target medium increases from within the first energy range to within the second energy range, thereby causing the fusion collisions to produce the neutrons with a gradually increasing neutron yield.
   30. The plasma focus method of aspect 29, wherein the first energy range extends from about 1 MeV to about 20 MeV, and wherein the second energy range extends from about 1 keV to about 200 keV.
   31. The plasma focus method of aspect 29 or 30, wherein the second energy range encompasses a maximum in the beam-target fusion cross-section between the beam ions and the target medium.
   32. The plasma focus method of aspect 31, wherein the maximum in the beam-target fusion cross-section between the beam ions and the target medium is at a beam ion energy of about 115 keV.
   33. The plasma focus method of any one of aspects 28 to 32, wherein the beam ions comprise deuterons and tritons, the target medium comprises a mixture of deuterium and tritium, and the neutrons are produced by the D-T fusion reaction.
   34. The plasma focus method of any one of aspects 28 to 32, wherein the beam ions comprise deuterons, the target medium comprises tritium, and the neutrons are produced by the D-T fusion reaction.
   35. The plasma focus method of any one of aspects 28 to 32, wherein the beam ions comprise deuterons, the target medium comprises deuterium, and the neutrons are produced by the D-D fusion reaction.
   36. The plasma focus method of any one of aspects 28 to 32, wherein the beam ions comprise tritons, the target medium comprises deuterium, and the neutrons are produced by the D-T fusion reaction.
   37. The plasma focus method of any one of aspects 28 to 35, wherein operating the plasma focus device comprises emitting primary neutrons, and wherein the neutrons produced by the neutron source correspond to secondary neutrons.
   38. The plasma focus method of any one of aspects 28 to 37, wherein the enclosure extends between a first enclosure end and a second enclosure, wherein the beam entrance port is provided at the first enclosure end, and wherein providing the neutron source comprises positioning the first enclosure end and the second enclosure end proximally to and distally from the plasma focus device, respectively.
   39. The plasma focus method of any one of aspects 28 to 38, wherein allowing at least part of the remnant ion beam to enter and travel inside the cavity comprises providing the enclosure with a beam entrance window.
   40. The plasma focus method of any one of aspects 28 to 38, wherein allowing at least part of the remnant ion beam to enter and travel inside the cavity comprises:
providing the enclosure with a beam shutter movable between a closed shutter position, wherein the remnant ion beam is prevented from entering the cavity, and an open shutter position, wherein the remnant ion beam is allowed to enter inside the cavity; and
switching the beam shutter from the closed shutter position to the open shutter position in coordination with the operating of the plasma focus device.
   41. The plasma focus method of any one of aspects 28 to 40, wherein the target medium is a target gas.
   42. The plasma focus method of aspect 41, wherein the target gas comprises deuterium, tritium, or a mixture of deuterium and tritium.
   43. The plasma focus method of aspect 41 or 42, further comprising controlling a fill pressure of the target gas inside the cavity to range from about 2 atm to about 6 atm.
   44. The plasma focus method of any one of aspects 41 to 43, wherein providing the neutron source comprises providing the enclosure with a length ranging from about 50 cm to about 2 m.
   45. The plasma focus method of any one of aspects 28 to 40, wherein the target medium is a target solid or a target liquid.
   46. The plasma focus method of aspect 45, wherein the target medium comprises D₂O ice or water, T₂O ice or water, or a mixture of D₂O ice or water and T₂O ice or water.
   47. The plasma focus method of aspect 45 or 46, wherein providing the neutron source comprises providing the enclosure with a length ranging from about 5 mm to about 20 mm.
   48. The plasma focus method of any one of aspects 28 to 47, wherein operating the plasma focus device comprises:
providing the plasma focus system with an inner electrode extending along a pinch axis between a discharge end and a focus end, and an outer electrode surrounding the inner electrode with an interelectrode gap therebetween defining an annular plasma channel;
supplying a process gas inside the plasma channel; and
applying a discharge driving signal to the inner electrode and the outer electrode to ionize the process gas into a plasma current sheath at the discharge end and flow the plasma current sheath along the plasma channel until the plasma current sheath reaches the focus end and radially collapses toward the pinch axis to form a plasma pinch generating the remnant ion beam.
   49. The plasma focus method of aspect 48, wherein applying the discharge driving signal comprises applying the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.
   50. The plasma focus method of aspect 48 or 49, wherein the process gas comprises deuterium, tritium, or a mixture of deuterium and tritium.
   51. The plasma focus method of any one of aspects 48 to 50, wherein providing the neutron source comprises positioning an enclosure axis of the enclosure in a coaxial arrangement with the pinch axis.

Numerous modifications could be made to the embodiments described above without departing from the scope of the appended claims.

### REFERENCES

The following is a list of references, the entire contents of which are incorporated herein by reference.
1. S. Auluck, et al. “Update on the Scientific Status of the Plasma Focus,” Plasma, vol. 4, no. 3, pp. 450-669 (2021).
2. J. D. Huba, NRL Plasma formulary, Naval Research Laboratory, Washington DC (2019). https://library.psfc.mit.edu/catalog/online_pubs/NRL_FORMULARY_19.pdf
3. S. Lee, “Description of Radiative Dense Plasma Focus Computation Package RADPFV5.16 and Downloads—Lee model code”: http://www.plasmafocus.net/IPFS/modelpackage/File1RADPF.htm
4. S. Lee, “Plasma Focus Radiative Model: Review of the Lee Model Code”, Journal of Fusion Energy, vol. 33, no. 4, pp. 319-335 (2014).

1. A plasma focus system for neutron production, the plasma focus system comprising:
a plasma focus device configured to emit a remnant ion beam comprising beam ions; and
a neutron source comprising an enclosure having a cavity formed therein for receiving a target medium, the enclosure comprising a beam entrance port configured to allow at least part of the remnant ion beam to enter and travel inside the cavity,
wherein, as the remnant ion beam travels along the cavity, the beam ions interact with the target medium and undergo fusion collisions, which produce neutrons and reduce a number of the beam ions, and non-fusion collisions, which reduce an energy of the beam ions.

2. The plasma focus system of claim 1, wherein, as the remnant ion beam travels inside the cavity, the non-fusion collisions gradually reduce the energy of the beam ions from a first energy range to a second energy range, and wherein a beam-target fusion cross-section between the beam ions and the target medium increases from within the first energy range to within the second energy range, thereby causing the fusion collisions to produce the neutrons with a gradually increasing neutron yield.

3. The plasma focus system of claim 2, wherein the first energy range extends from about 1 MeV to about 20 MeV, and wherein the second energy range extends from about 1 keV to about 200 keV.

4. The plasma focus system of claim 2, wherein the second energy range encompasses a maximum in the beam-target fusion cross-section between the beam ions and the target medium.

5. The plasma focus system of claim 4, wherein the maximum in the beam-target fusion cross-section between the beam ions and the target medium is at a beam ion energy of about 115 keV.

6. The plasma focus system of claim 1, wherein the beam ions comprise deuterons and tritons, the target medium comprises a mixture of deuterium and tritium, and the neutrons are produced by the D-T fusion reaction.

7. The plasma focus system of claim 1, wherein the beam ions comprise deuterons, the target medium comprises tritium, and the neutrons are produced by the D-T fusion reaction.

8. The plasma focus system of claim 1, wherein the beam ions comprise deuterons, the target medium comprises deuterium, and the neutrons are produced by the D-D fusion reaction.

9. The plasma focus system of claim 1, wherein the beam ions comprise tritons, the target medium comprises deuterium, and the neutrons are produced by the D-T fusion reaction.

10. The plasma focus system of claim 1, wherein the plasma focus device further emits primary neutrons, and wherein the neutrons produced by the neutron source correspond to secondary neutrons.

11. The plasma focus system of claim 1, wherein the enclosure extends between a first enclosure end, proximal to the plasma focus device, and a second enclosure end distal from the plasma focus device, and wherein the beam entrance port is provided at the first enclosure end.

12. The plasma focus system of claim 1, wherein the beam entrance port comprises a beam entrance window.

13. The plasma focus system of claim 1, wherein the beam entrance port comprises a beam shutter, wherein the beam shutter is movable between a closed shutter position, wherein the remnant ion beam is prevented from entering the cavity, and an open shutter position, wherein the remnant ion beam is allowed to enter inside the cavity.

14. The plasma focus system of claim 1, wherein the target medium is a target gas.

15. The plasma focus system of claim 14, wherein the target gas comprises deuterium, tritium, or a mixture of deuterium and tritium.

16. The plasma focus system of claim 14, wherein a fill pressure of the target gas inside the cavity ranges from about 2 atm to about 6 atm.

17. The plasma focus system of claim 1, wherein the enclosure has a length ranging from about 50 cm to about 2 m.

18. The plasma focus system of claim 1, wherein the target medium is a target solid.

19. The plasma focus system of claim 18, wherein the target solid comprises D₂O ice, T₂O ice, or a mixture of D₂O ice and T₂O ice.

20. The plasma focus system of claim 18, wherein the enclosure has a length ranging from about 5 mm to about 20 mm.

21. The plasma focus system of claim 1, wherein the target medium is a target liquid.

22. The plasma focus system of claim 21, wherein the target liquid comprises D₂O water, T₂O water, or a mixture of D₂O water and T₂O water.

23. The plasma focus system of claim 21, wherein the enclosure has a length ranging from about 5 mm to about 20 mm.

24. The plasma focus system of claim 1, wherein the plasma focus device comprises:
an electrode assembly comprising:
an inner electrode extending along a pinch axis between a discharge end and a focus end; and
an outer electrode surrounding the inner electrode and defining therebetween a plasma channel configured to receive a process gas; and
a power supply unit configured to apply a discharge driving signal to the inner electrode and the outer electrode, wherein applying the discharge driving signal causes the process gas to be ionized into a plasma current sheath at the discharge end and the plasma current sheath to flow along the plasma channel and reach the focus end where the plasma current sheath collapses toward the pinch axis to form a plasma pinch from which the remnant ion beam is emitted.

25. The plasma focus system of claim 24, wherein the enclosure extends along an enclosure axis that is coaxial with respect to the pinch axis.

26. The plasma focus system of claim 24, wherein the plasma focus device comprises a vacuum chamber configured to contain the process gas therein and to house at least part of the enclosure, including the beam entrance port.

27. The plasma focus system of claim 24, wherein the process gas comprises deuterium, tritium, or a mixture of deuterium and tritium.

28. A plasma focus method of neutron production, the method comprising:
operating a plasma focus device to emit a remnant ion beam comprising beam ions;
providing a neutron source comprising an enclosure having a cavity with a target medium thereinside; and
allowing at least part of the remnant ion beam to enter and travel inside the cavity, wherein, as the remnant ion beam travels inside the cavity, the beam ions interact with the target mediums and undergo fusion collisions, which produce neutrons and reduce a number of the beam ions, and non-fusion collisions, which reduce an energy of the beam ions.

29. The plasma focus method of claim 28, wherein, as the remnant ion beam travels inside the cavity, the non-fusion collisions gradually reduce the energy of the beam ions from a first energy range to a second energy range, and wherein a beam-target fusion cross-section between the beam ions and the target medium increases from within the first energy range to within the second energy range, thereby causing the fusion collisions to produce the neutrons with a gradually increasing neutron yield.

30. The plasma focus method of claim 29, wherein the first energy range extends from about 1 MeV to about 20 MeV, and wherein the second energy range extends from about 1 keV to about 200 keV.

31. The plasma focus method of claim 29, wherein the second energy range encompasses a maximum in the beam-target fusion cross-section between the beam ions and the target medium.

32. The plasma focus method of claim 31, wherein the maximum in the beam-target fusion cross-section between the beam ions and the target medium is at a beam ion energy of about 115 keV.

33. The plasma focus method of claim 28, wherein the beam ions comprise deuterons and tritons, the target medium comprises a mixture of deuterium and tritium, and the neutrons are produced by the D-T fusion reaction.

34. The plasma focus method of claim 28, wherein the beam ions comprise deuterons, the target medium comprises tritium, and the neutrons are produced by the D-T fusion reaction.

35. The plasma focus method of claim 28, wherein the beam ions comprise deuterons, the target medium comprises deuterium, and the neutrons are produced by the D-D fusion reaction.

36. The plasma focus method of claim 28, wherein the beam ions comprise tritons, the target medium comprises deuterium, and the neutrons are produced by the D-T fusion reaction.

37. The plasma focus method of claim 28, wherein operating the plasma focus device comprises emitting primary neutrons, and wherein the neutrons produced by the neutron source correspond to secondary neutrons.

38. The plasma focus method of claim 28, wherein the enclosure extends between a first enclosure end and a second enclosure, wherein the beam entrance port is provided at the first enclosure end, and wherein providing the neutron source comprises positioning the first enclosure end and the second enclosure end proximally to and distally from the plasma focus device, respectively.

39. The plasma focus method of claim 28, wherein allowing at least part of the remnant ion beam to enter and travel inside the cavity comprises providing the enclosure with a beam entrance window.

40. The plasma focus method of claim 28, wherein allowing at least part of the remnant ion beam to enter and travel inside the cavity comprises:
providing the enclosure with a beam shutter movable between a closed shutter position, wherein the remnant ion beam is prevented from entering the cavity, and an open shutter position, wherein the remnant ion beam is allowed to enter inside the cavity; and
switching the beam shutter from the closed shutter position to the open shutter position in coordination with the operating of the plasma focus device.

41. The plasma focus method of claim 28, wherein the target medium is a target gas.

42. The plasma focus method of claim 41, wherein the target gas comprises deuterium, tritium, or a mixture of deuterium and tritium.

43. The plasma focus method of claim 41, further comprising controlling a fill pressure of the target gas inside the cavity to range from about 2 atm to about 6 atm.

44. The plasma focus method of claim 41, wherein providing the neutron source comprises providing the enclosure with a length ranging from about 50 cm to about 2 m.

45. The plasma focus method of claim 28, wherein the target medium is a target solid or a target liquid.

46. The plasma focus method of claim 45, wherein the target medium comprises D₂O ice or water, T₂O ice or water, or a mixture of D₂O ice or water and T₂O ice or water.

47. The plasma focus method of claim 45, wherein providing the neutron source comprises providing the enclosure with a length ranging from about 5 mm to about 20 mm.

48. The plasma focus method of claim 28, wherein operating the plasma focus device comprises:
providing the plasma focus system with an inner electrode extending along a pinch axis between a discharge end and a focus end, and an outer electrode surrounding the inner electrode with an interelectrode gap therebetween defining an annular plasma channel;
supplying a process gas inside the plasma channel; and
applying a discharge driving signal to the inner electrode and the outer electrode to ionize the process gas into a plasma current sheath at the discharge end and flow the plasma current sheath along the plasma channel until the plasma current sheath reaches the focus end and radially collapses toward the pinch axis to form a plasma pinch generating the remnant ion beam.

49. The plasma focus method of claim 48, wherein applying the discharge driving signal comprises applying the discharge driving signal as a voltage pulse having a peak magnitude ranging from about 12 kV to about 1 MV, a half-cycle pulse duration ranging from about 1 μs to about 50 μs, and a peak current amplitude ranging from about 100 kA to about 10 MA.

50. The plasma focus method of claim 48, wherein the process gas comprises deuterium, tritium, or a mixture of deuterium and tritium.

51. The plasma focus method of claim 48, wherein providing the neutron source comprises positioning an enclosure axis of the enclosure in a coaxial arrangement with the pinch axis.
